(19) United States
(12) Patent Application Publication
(10) Pub. No.: US 2026/0138362 A1
(43) Pub. Date: May 21, 2026

(54) Control Method, Liquid Ejecting Apparatus, And Ink Jet System

(71) Applicant: SEIKO EPSON CORPORATION, Tokyo (JP)

(72) Inventors: Akira MIYAGISHI, Shiojiri (JP); Shunya FUKUDA, Azumino (JP); Nobuaki ITO, Suwa (JP)

(21) Appl. No.: 19/389,266

(22) Filed: Nov. 14, 2025

(30) Foreign Application Priority Data
Nov. 15, 2024 (JP) 2024-199519

(51) Int. Cl. B41J 2/045; B41J 2/14; B41J 2/165; B41J 29/393; G01H 11/08

(52) U.S. Cl. CPC B41J 2/0451; B41J 2/04581; B41J 2/1433; B41J 2/16579; B41J 29/393; G01H 11/08

(57) ABSTRACT

A control method of a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, includes an acquisition step of acquiring residual vibration information on residual vibrations in the pressure chambers after applying a voltage to one or more of the plurality of piezoelectric elements, and a determination step of determining whether or not a first abnormality, which is an abnormality caused by the medium colliding with the liquid ejecting head, is generated based on the residual vibration information.

The present application is based on, and claims priority from JP Application Serial Number 2024-199519, filed Nov. 15, 2024, the disclosure of which is hereby incorporated by reference herein in its entirety.

### BACKGROUND

### 1. Technical Field

The present disclosure relates to a control method, a liquid ejecting apparatus, and an ink jet system.

### 2. Related Art

In the related art, a liquid ejecting apparatus including a liquid ejecting head that ejects a liquid on a medium such as printing paper is provided. In such a liquid ejecting apparatus, an ejection abnormality in which a liquid cannot be normally ejected from a nozzle may be generated due to a liquid ejecting head, such as thickening of a liquid in the liquid ejecting head. For example, JP-A-2004-314459 describes a technique for determining the presence or absence of an ejection abnormality of a liquid ejecting head, such as air bubbles mixed in a liquid in the liquid ejecting head, thickening of the liquid in the liquid ejecting head, and the liquid leaked onto a nozzle surface of the liquid ejecting head, based on a residual vibration generated after the liquid ejecting head is driven.

In the above-described liquid ejecting head, in addition to the mixing of air bubbles, the thickening of the liquid, and the leakage, the ejection abnormality may be generated due to the collision of the medium with the liquid ejecting head. However, in the related art, it is difficult to determine whether or not an abnormality is generated due to the collision of the medium with the liquid ejecting head.

### SUMMARY

According to an aspect of the present disclosure, there is provided a control method of a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, the control method including an acquisition step of acquiring residual vibration information on residual vibrations in the pressure chambers after applying a voltage to one or more of the plurality of piezoelectric elements, and a determination step of determining whether or not a first abnormality, which is an abnormality caused by the medium colliding with the liquid ejecting head, is generated based on the residual vibration information.

According to another aspect of the present disclosure, there is provided a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, the liquid ejecting apparatus including an acquisition section configured to acquire residual vibration information on residual vibrations in the pressure chambers after applying a voltage to one or more of the plurality of piezoelectric elements, and a determination section configured to determine whether or not a first abnormality, which is an abnormality caused by the medium colliding with the liquid ejecting head, is generated based on the residual vibration information.

According to still another aspect of the present disclosure, there is provided an ink jet system including a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, and a server provided outside the liquid ejecting apparatus, in which the liquid ejecting apparatus acquires residual vibration information on residual vibrations in the pressure chambers after applying a voltage to one or more of the plurality of piezoelectric elements, and transmits the residual vibration information from the liquid ejecting apparatus to the server, and the server determines whether or not a first abnormality, which is an abnormality caused by the medium colliding with the liquid ejecting head, is generated based on the residual vibration information.

### BRIEF DESCRIPTION OF THE DRAWINGS

FIG. 1 is a schematic diagram illustrating a configuration example of an ink jet system according to a first embodiment.

FIG. 2 is a diagram illustrating an example of a configuration of a server.

FIG. 3 is a diagram illustrating a configuration of a processing apparatus.

FIG. 4 is a schematic diagram illustrating an example of a configuration of an ink jet printer.

FIG. 5 is a block diagram illustrating a configuration example of the ink jet printer.

FIG. 6 is a cross-sectional view illustrating a configuration example of a head chip.

FIG. 7 is an enlarged cross-sectional view illustrating a vicinity of a piezoelectric element.

FIG. 8 is a block diagram illustrating an example of a configuration of a liquid ejecting head.

FIG. 9 is a diagram illustrating a timing chart for describing an operation of the ink jet printer in a recording period.

FIG. 10 is a diagram illustrating functions of the ink jet system.

FIG. 11 is a flowchart illustrating operations of the ink jet system.

FIG. 12 is a flowchart illustrating abnormality determination processing of a nozzle row.

FIG. 13 is a diagram for describing a determination method of determining whether or not a residual vibration is abnormal.

FIG. 14 is a flowchart illustrating operations of the ink jet system according to a second embodiment.

FIG. 15 is a flowchart illustrating medium collision abnormality determination processing of the nozzle row.

FIG. 16 is a flowchart illustrating pre-existing head abnormality determination processing of the nozzle row.

FIG. 17 is a flowchart illustrating operations of the ink jet system according to a first modification example.

FIG. 18 is a diagram illustrating functions of an ink jet printer according to a second modification example.

### DESCRIPTION OF EMBODIMENTS

Hereinafter, embodiments for carrying out the present disclosure will be described with reference to the drawings. However, in each drawing, the dimensions and scales of each part are appropriately different from the actual ones. In addition, since the embodiment described below is a suitable specific example of the present disclosure, various technically preferable limitations are added, and the scope of the present disclosure is not limited to these embodiments unless otherwise stated in the following description to particularly limit the present disclosure.

### 1. First Embodiment

### 1-1. Overview of Ink Jet System 10

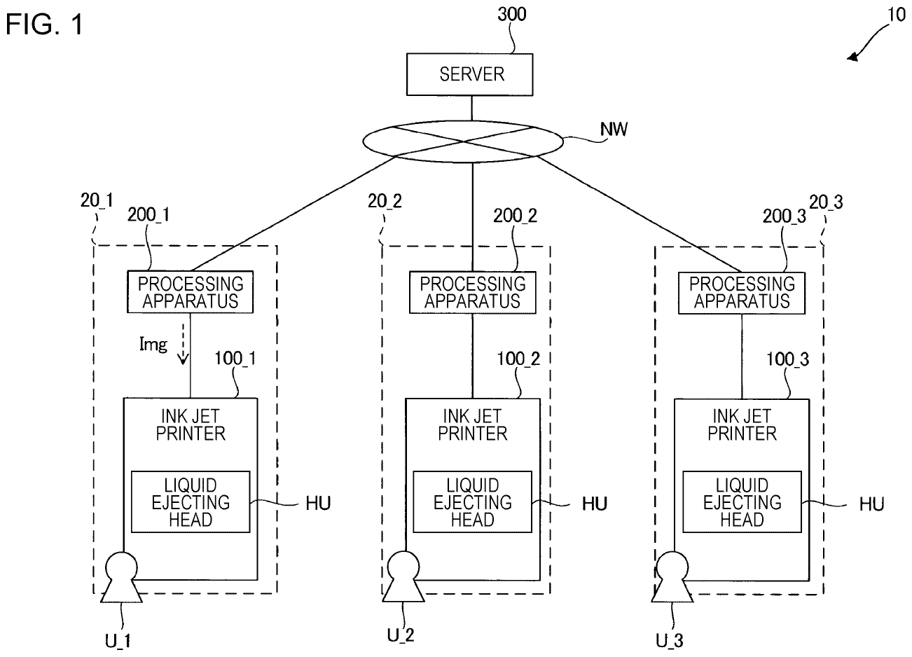

FIG. 1 is a schematic diagram illustrating a configuration example of an ink jet system 10 according to a first embodiment. The ink jet system 10 is a system that performs recording processing on a medium PP, which will be described later, by an ink jet method. In the example illustrated in FIG. 1, the ink jet system 10 includes ink jet printers 100_1 to 100_3, processing apparatuses 200_1 to 200_3, and a server 300.

Here, the ink jet printers 100_1 to 100_3 are apparatuses provided by a manufacturer of the ink jet printers 100_1 to 100_3. In the following description, the ink jet printers 100_1 to 100_3 may be collectively referred to as an ink jet printer 100 without distinguishing among them. The ink jet printer 100 is a liquid ejecting apparatus that ejects ink, which is an example of a liquid. A manufacturer of the ink jet printer 100 is a company that manufactures the ink jet printer 100. The manufacturer of the ink jet printer 100 may be referred to as a “printer manufacturer”. Each of the ink jet printers 100_1 to 100_3 may be provided by the same printer manufacturer or may be provided by different printer manufacturers. However, liquid ejecting heads HU incorporated in the ink jet printers 100_1 to 100_3 are provided by the manufacturer of the liquid ejecting head HU. The manufacturer of the liquid ejecting head HU is a company that manufactures the liquid ejecting head HU. Hereinafter, the manufacturer of the liquid ejecting head HU may be referred to as a “head manufacturer”. The printer manufacturer receives the provision of the liquid ejecting head HU from the head manufacturer, and manufactures the ink jet printer 100 by incorporating the provided liquid ejecting head HU into the ink jet printer 100. The ink jet printer 100 is an example of a “liquid ejecting apparatus”.

FIG. 1 illustrates a user U_1 who uses the ink jet printer 100_1, a user U_2 who uses the ink jet printer 100_2, and a user U_3 who uses the ink jet printer 100_3. In the following description, the users U_1 to U_3 may be collectively referred to as a user U without distinguishing each of the users U_1 to U_3. For the user U, for example, when a worker belonging to a printer manufacturer uses the ink jet printer 100, this worker is the user U. In addition, for example, when a third party who receives the provision of the ink jet printer 100 from the printer manufacturer uses the ink jet printer 100, this third party is the user U. In the following description, the third party who receives the provision of the ink jet printer 100 from the printer manufacturer may be referred to as an “end user”. For each integer i from 1 to 3, a user U_i uses a processing apparatus 200_i in addition to an ink jet printer 100_i.

The ink jet printer 100_1 is communicatively connected to the processing apparatus 200_1. The ink jet printer 100_2 is communicatively connected to the processing apparatus 200_2. The ink jet printer 100_3 is communicatively connected to the processing apparatus 200_3. In this way, the ink jet printers 100_1 to 100_3 correspond to the processing apparatuses 200_1 to 200_3, respectively, and are communicatively connected to the processing apparatuses 200_1 to 200_3. In the following description, the processing apparatuses 200_1 to 200_3 may be collectively referred to as a processing apparatus 200 without distinguishing each of the processing apparatuses 200_1 to 200_3.

In addition, in the following, a recording system 20_i may be described for each integer i from 1 to 3. The recording system 20_i includes the ink jet printer 100_i and the processing apparatus 200_i. In the following description, recording systems 20_1 to 20_3 may be collectively referred to as a recording system 20 without distinguishing each of the recording systems 20_1 to 20_3. It can be said that the ink jet system 10 includes the recording systems 20_1 to 20_3 and the server 300.

In the example illustrated in FIG. 1, the number of each of the ink jet printers 100 and the processing apparatuses 200 included in the ink jet system 10 is three, but the number is not limited thereto, and may be one, two, or four or more. That is, the number of sets of the ink jet printer 100 and the processing apparatus 200 is not limited to three sets, and may be one, two, or four or more sets.

The ink jet printer 100 receives image data Img indicating an image from the processing apparatus 200. The ink jet printer 100 forms an image based on the image data Img on the medium PP. Hereinafter, processing for forming an image on the medium PP by ejecting the ink onto the medium PP may be referred to as “recording processing”.

The medium PP is not particularly limited as long as it is a medium on which the ink jet printer 100 can print, and is, for example, various types of paper such as printing paper, various types of cloths, various types of films, or the like.

The ink jet printer 100 has the one liquid ejecting head HU. In the following description, the liquid ejecting head HU ejects ink from a nozzle Nz provided in the liquid ejecting head HU. In the following, among the elements constituting the ink jet printer 100, the elements other than the liquid ejecting head HU may be referred to as a “printer main body”.

In the example illustrated in FIG. 1, the ink jet printer 100 has the one liquid ejecting head HU, but the number of the liquid ejecting heads HU is not limited to one, and may be two or more.

The processing apparatus 200 is a desktop or laptop computer, or the like. The processing apparatus 200 is communicatively connected to the server 300 via a network NW such as a LAN, a WAN, and the Internet. LAN is an abbreviation for Local Area Network. WAN is an abbreviation for Wide Area Network.

The server 300 is a computer that functions as a cloud server CS, which will be described later. The server 300 is managed by, for example, a provider different from a head manufacturer, a printer manufacturer, and an end user. Hereinafter, the provider that manages the server 300 may be referred to as a “server provider”. The head manufacturer uses a part of the server 300.

### 1-2. Configuration of Server 300

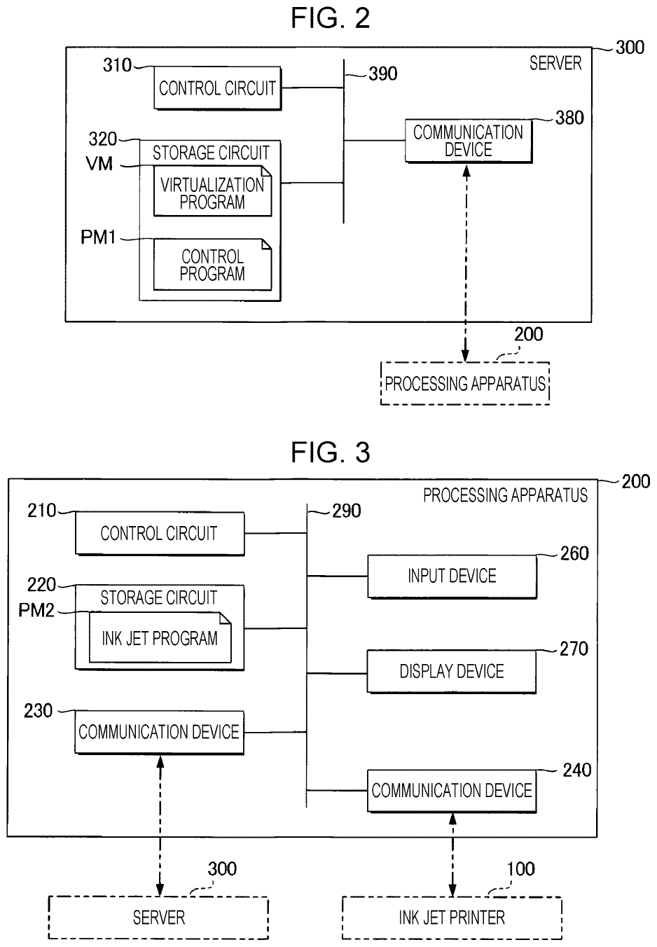

FIG. 2 is a diagram illustrating an example of a configuration of the server 300. The server 300 includes a control circuit 310, a storage circuit 320, and a communication device 380. The control circuit 310, the storage circuit 320, and the communication device 380 are coupled to one another via a bus 390 for communicating information.

The control circuit 310 includes, for example, a processor such as one or more CPUs. CPU is an abbreviation for Central Processing Unit. The control circuit 310 may include a programmable logic device such as an FPGA instead of or in addition to the CPU. FPGA is an abbreviation for Field Programmable Gate Array.

The storage circuit 320 is composed of a magnetic storage device, a flash ROM, or the like. The storage circuit 320 is readable by the control circuit 310, and stores a plurality of programs including a virtualization program VM and a control program PM1 executed by the control circuit 310, various types of information used by the control circuit 310, or the like. The virtualization program VM divides resources such as the control circuit 310 and the storage circuit 320 of the server 300 into a plurality of resources, and operates each of the divided resources as the cloud server CS. The head manufacturer uses some of the cloud servers CS among a plurality of cloud servers CS as a part of the server 300. The control program PM1 is developed by the head manufacturer.

However, the storage circuit 320 may not have the virtualization program VM, and the processing apparatus 200 may access the server 300 instead of the cloud server CS.

The storage circuit 320 includes, for example, one or both semiconductor memories of one or more volatile memories such as a RAM and one or more non-volatile memories such as a ROM, an EEPROM, or a PROM. RAM is an abbreviation for Random Access Memory. ROM is an abbreviation for Read Only Memory. EEPROM is an abbreviation for Electrically Erasable Programmable Read-Only Memory. PROM is an abbreviation for Programmable ROM.

The communication device 380 is hardware having a communication circuit for communicating with the processing apparatus 200 via the network NW. The communication device 380 is also referred to as a network device, a network controller, a network card, or a communication module, for example.

### 1-3. Configuration of Processing Apparatus 200

FIG. 3 is a diagram illustrating a configuration of the processing apparatus 200. The processing apparatus 200 includes a control circuit 210, a storage circuit 220, a communication device 230, an input device 260, and a display device 270. The control circuit 210, the storage circuit 220, the communication device 230, the input device 260, and the display device 270 are coupled to one another via a bus 290 for Communicating Information.

The control circuit 210 includes, for example, a processor such as one or more CPUs. The control circuit 210 may include a programmable logic device such as an FPGA instead of or in addition to the CPU.

The storage circuit 220 is composed of a magnetic storage device, a flash ROM, or the like. The storage circuit 220 is readable by the control circuit 210, and stores a plurality of programs including an ink jet program PM2 executed by the control circuit 210, various types of information used by the control circuit 210, or the like. The storage circuit 220 includes, for example, one or both semiconductor memories of one or more volatile memories such as a RAM and one or more non-volatile memories such as a ROM, an EEPROM, or a PROM. When the processing apparatus 200 is coupled to the ink jet printer 100, the ink jet program PM2 is downloaded from the cloud server CS operating on the server 300 and installed in the processing apparatus 200, for example. The ink jet program PM2 is, for example, a program that generates the image data Img. More specifically, the ink jet program PM2 generates the image data Img indicating an image generated by the application program. The application program is, for example, an application program that creates a document and an application program that creates an image.

The communication device 230 is hardware having a communication circuit to communicate with the processing apparatus 200 via the network NW. The communication device 230 is also referred to as a network device, a network controller, a network card, or a communication module, for example.

The communication device 240 is a circuit configured to communicate with the ink jet printer 100. For example, the communication device 240 is a network card such as a USB or Bluetooth. USB is an abbreviation for Universal Serial Bus. USB and Bluetooth are registered trademarks.

The input device 260 is a device that outputs operation information according to the operation of the user U. The input device 260 is, for example, a mouse and a keyboard.

The display device 270 displays an image indicating some information to the user U. The display device 270 is an organic EL display, an LED display, and an LCD. EL is an abbreviation for Electro-Luminescence. LED is an abbreviation for Light Emitting Diode. LCD is an abbreviation for Liquid Crystal Display. In addition, a configuration in which the input device 260 and the display device 270 are integrated may be used. The configuration in which the input device 260 and the display device 270 are integrated is, for example, a touch panel.

As illustrated in FIGS. 1 to 3, there is a business model in which the head manufacturer provides the liquid ejecting head HU to the printer manufacturer, and the printer manufacturer manufactures the ink jet printer 100 by incorporating the liquid ejecting head HU into the printer main body. In this business model, printer manufacturers generally design and manufacture components other than the liquid ejecting head HU. In the present embodiment, the head manufacturer prepares the cloud server CS and the ink jet program PM2 that operates on the processing apparatus 200, and the user U connects the processing apparatus 200 to the cloud server CS and causes the processing apparatus 200 to operate the ink jet program PM2. As described above, in the present embodiment, since the printer manufacturer does not need to prepare the ink jet program PM2, the load of the printer manufacturer for designing and manufacturing components can be reduced.

### 1-4. Configuration of Ink Jet Printer 100

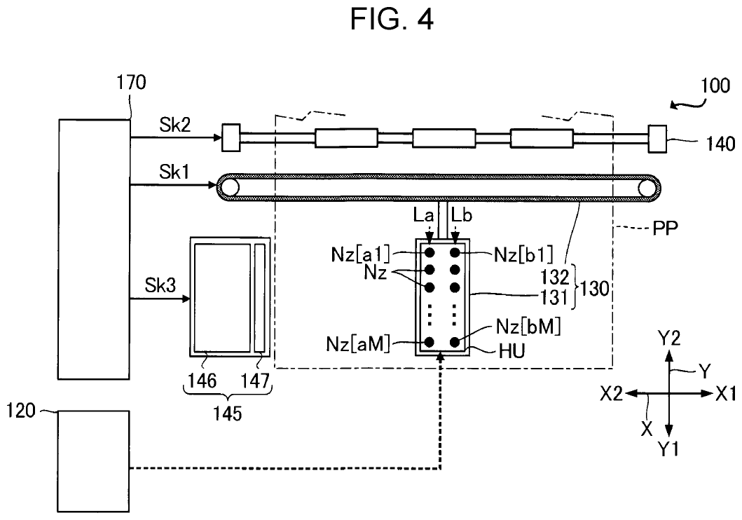

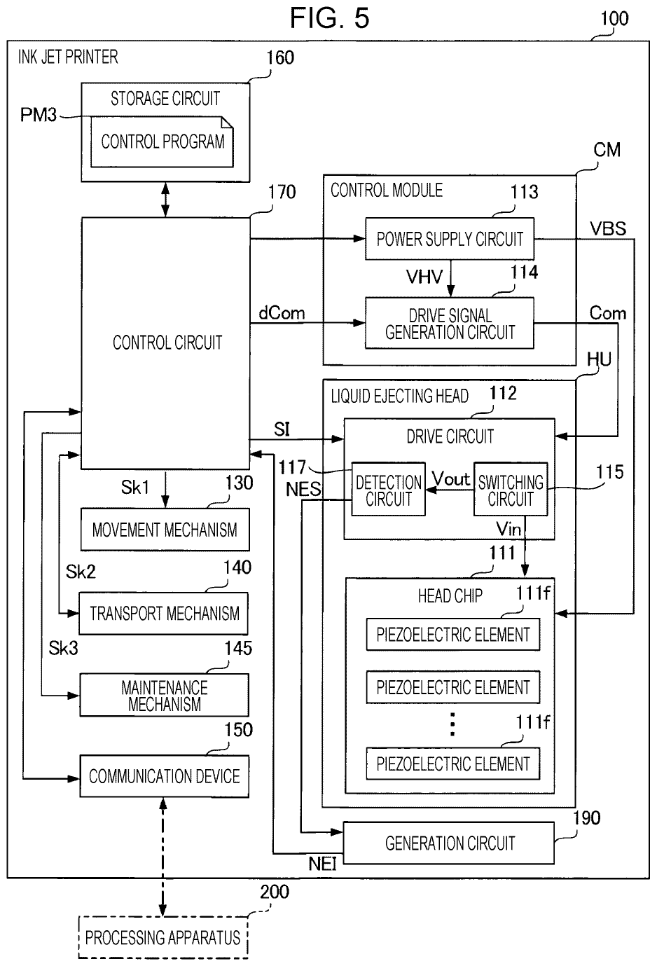

FIG. 4 is a schematic diagram illustrating an example of a configuration of the ink jet printer 100. FIG. 5 is a block diagram illustrating a configuration example of the ink jet printer 100. In the following description, an X-axis, a Y-axis, and a Z-axis which are orthogonal to each other are assumed. One direction along the X-axis when viewed from an optional point is referred to as an X1 direction, and a direction opposite to the X1 direction is referred to as an X2 direction. Similarly, directions opposite to each other along the Y-axis from an optional point are referred to as a Y1 direction and a Y2 direction, and directions opposite to each other along the Z-axis from an optional point are referred to as a Z1 direction and a Z2 direction. An X-Y plane including the X-axis and the Y-axis corresponds to a horizontal plane. The Z-axis is an axis along a vertical direction, and the Z2 direction corresponds to a downward direction in the vertical direction.

The ink jet printer 100 according to the first embodiment is a serial type printer that reciprocates the liquid ejecting head HU along the X-axis. Specifically, as illustrated in FIG. 4, the ink jet printer 100 according to the first embodiment executes an ejection operation of forming an image on the medium PP by ejecting ink from the nozzle Nz as the medium PP is transported in the Y1 direction, which is a sub-scanning direction, and moving the liquid ejecting head HU in the X1 direction and the X2 direction, which are main scanning directions. In FIG. 4, some nozzles Nz of a plurality of nozzles Nz included in the liquid ejecting head HU are representatively illustrated.

As illustrated in FIG. 4, the plurality of nozzles Nz included in the liquid ejecting head HU are classified into a nozzle row La and a nozzle row Lb that are arranged at intervals in the direction along the X-axis. Each of the nozzle row La and the nozzle row Lb is a set of the plurality of nozzles Nz linearly arranged in a direction along the Y-axis. In the following description, it is assumed that the number of the nozzles Nz included in the nozzle row La and the nozzle row Lb is M, which is one or more. Therefore, the number of the nozzles Nz included in the liquid ejecting head HU is 2M. Then, in order to distinguish each of the 2M nozzles Nz, the nozzle Nz classified into the nozzle row La may be referred to as a nozzle Nz[am1], and the nozzle Nz classified into the nozzle row Lb may be referred to as a nozzle Nz[bm2]. m1 and m2 are integers of 1 or greater and M or less. In addition, in the following, the nozzle Nz[a1] to the nozzle Nz[aM] and the nozzle Nz[b1] to the nozzle Nz[bM] may be referred to as the nozzle Nz without distinction. In addition, when designating any one of the N nozzles Nz, the nozzle may be referred to as a nozzle Nz[x]. x is any one of the character strings from a1 to aM and from b1 to bM.

In the present embodiment, as illustrated in FIG. 4, among the M nozzles Nz classified into the nozzle row La, the nozzle Nz disposed furthest in the Y2 direction is referred to as the nozzle Nz[a1], and the nozzle Nz disposed furthest in the Y1 direction is referred to as the nozzle Nz[aM]. In addition, among the M nozzles Nz classified into the nozzle row Lb, the nozzle Nz disposed furthest in the Y2 direction is referred to as the nozzle Nz[b1], and the nozzle Nz disposed furthest in the Y1 direction is referred to as the nozzle Nz[bM].

As illustrated in FIGS. 4 and 5, the ink jet printer 100 includes a control module CM, the liquid ejecting head HU, a liquid container 120, a movement mechanism 130, a transport mechanism 140, a maintenance mechanism 145, a communication device 150, a storage circuit 160, and a control circuit 170.

The control module CM includes a power supply circuit 113 and a drive signal generation circuit 114. The liquid ejecting head HU is an assembly including a head chip 111 and a drive circuit 112. The liquid ejecting head HU may incorporate a part or all of the control module CM.

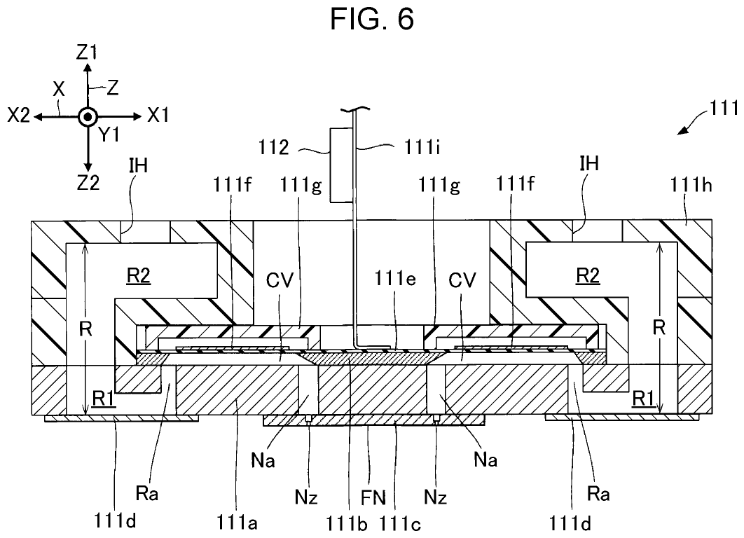

The head chip 111 ejects ink toward the medium PP. In FIG. 4, among the components of the head chip 111, 2M piezoelectric elements 111f are representatively illustrated. A detailed example of the head chip 111 will be described later with reference to FIG. 6.

In the example illustrated in FIG. 5, the number of the head chips 111 included in the liquid ejecting head HU is one, but the number may be two or more. One or more head chips 111 are disposed such that the plurality of nozzles Nz are distributed over a part of the medium PP in a width direction.

Under the control of the control circuit 170, the drive circuit 112 switches whether or not to supply a drive signal Com output from the drive signal generation circuit 114 to each of a plurality of piezoelectric elements 111f included in the head chip 111.

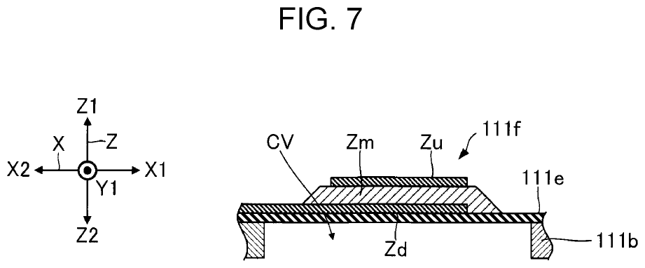

The drive circuit 112 includes a switching circuit 115 and a detection circuit 117. Under the control of the control circuit 170, the switching circuit 115 switches whether or not to supply the drive signal Com output from the drive signal generation circuit 114 to each of the 2M piezoelectric elements 111f included in the head chip 111 coupled to the drive circuit 112. In addition, the switching circuit 115 switches whether or not to electrically couple each of the piezoelectric elements 111f and the detection circuit 117. In the present embodiment, it is assumed that the drive signal Com includes a drive signal Com-A and a drive signal Com-B. Further, among the drive signals Com-A and Com-B, a signal actually supplied to the piezoelectric element 111f may be referred to as a supply drive signal Vin. The switching circuit 115 includes, for example, a group of switches such as a transmission gate for the switching. Details of the switching circuit 115 will be described later with reference to FIG. 7. The detection circuit 117 outputs a residual vibration signal NES indicating the vibration remaining in a pressure chamber CV, which will be described later, to a generation circuit 190 after the piezoelectric element 111f is driven. More specifically, the detection circuit 117 generates the residual vibration signal NES based on a detection signal Vout detected from the piezoelectric element 111f driven by the drive signal Com.

The power supply circuit 113 receives electric power from a commercial power supply (not illustrated) and generates various types of predetermined potentials. The generated various types of potentials are appropriately supplied to each section of the ink jet printer 100. In the example illustrated in FIG. 5, the power supply circuit 113 generates a power supply potential VHV and an offset potential VBS. The offset potential VBS is supplied to the head chip 111 or the like. In addition, the power supply potential VHV is supplied to the drive signal generation circuit 114 or the like.

The drive signal generation circuit 114 is a circuit that generates the drive signal Com to drive each of the piezoelectric elements 111f included in the head chip 111. Specifically, the drive signal generation circuit 114 includes, for example, a DA conversion circuit and an amplifier circuit. In the drive signal generation circuit 114, the DA conversion circuit converts a waveform designation signal dCom to be described later from the control circuit 170 from a digital signal to an analog signal, and the amplifier circuit generates the drive signal Com by amplifying the analog signal by using the power supply potential VHV from the power supply circuit 113.

As illustrated in FIG. 4, the liquid container 120 that stores ink is installed in the ink jet printer 100. For example, a cartridge that is detachably attached to the ink jet printer 100, a bag-shaped ink pack formed of a flexible film, or an ink tank that can be replenished with ink is used as the liquid container 120.

The movement mechanism 130 and the transport mechanism 140 move the relative positions of the medium PP and the liquid ejecting head HU under the control of the control circuit 170. The movement of the relative position means that the liquid ejecting head HU may be moved as the position of the medium PP is fixed, or the medium PP may be moved as the position of the liquid ejecting head HU is fixed. In the present embodiment, with respect to the direction along the X-axis that is the main scanning direction, the liquid ejecting head HU is moved in the direction along the X-axis as the position of the medium PP in the X-axis is fixed, and with respect to the Y1 direction that is the sub-scanning direction, the medium PP is moved in the Y1 direction as the position of the liquid ejecting head HU in the direction along the Y-axis is fixed.

The movement mechanism 130 causes the liquid ejecting head HU to reciprocate along the X-axis under the control of the control circuit 170. As illustrated in FIG. 4, the movement mechanism 130 includes a substantially box-shaped carriage 131 that accommodates the liquid ejecting head HU, and an endless belt 132 to which the liquid ejecting head HU is fixed. A configuration in which the liquid container 120 is mounted on the carriage 131 together with the liquid ejecting head HU can also be employed.

The transport mechanism 140 transports the medium PP in the Y1 direction under the control of the control circuit 170. Specifically, the transport mechanism 140 includes a transport roller (not illustrated) having a rotation shaft parallel to the X-axis, a motor (not illustrated) that rotates the transport roller under the control of the control circuit 170, and an encoder that outputs a signal corresponding to the rotation amount of the transport roller and corresponding to the transport position of the medium PP transported corresponding to the rotation drive of the transport roller, to the control circuit 170.

The communication device 150 is a circuit configured to communicate with the processing apparatus 200. For example, the communication device 150 is a network card such as a USB or Bluetooth. In addition, the communication device 150 may be integrated with the control circuit 170.

The storage circuit 160 stores various programs including a control program PM3 executed by the control circuit 170 and various types of data such as the image data Img processed by the control circuit 170. The storage circuit 160 includes, for example, one or both semiconductor memories of one or more volatile memories such as a RAM and one or more non-volatile memories such as a ROM, an EEPROM, or a PROM. The storage circuit 160 may be configured as a portion of the control circuit 170.

The control circuit 170 has a function of controlling the operation of each section of the ink jet printer 100 and a function of processing various types of data. The control circuit 170 includes, for example, a processor such as one or more CPUs. The control circuit 170 may include a programmable logic device such as an FPGA instead of or in addition to the CPU.

The control circuit 170 controls the operation of each section of the ink jet printer 100 by executing a program stored in the storage circuit 160. Here, the control circuit 170 generates signals such as a control signal Sk1, a control signal Sk2, a control signal Sk3, a print signal SI, and the waveform designation signal dCom as signals for controlling the operation of each section of the ink jet printer 100.

The control signal Sk1 is a signal for controlling driving of the movement mechanism 130. The control signal Sk2 is a signal for controlling driving of the transport mechanism 140. The control signal Sk3 is a signal for controlling the maintenance mechanism 145. The print signal SI is a signal for controlling driving the drive circuit 112. Specifically, the print signal SI designates whether or not the drive circuit 112 supplies the drive signal Com from the drive signal generation circuit 114 to the piezoelectric element 111f for each predetermined unit period. By this designation, the amount of ink ejected from the head chip 111 or the like is designated. The waveform designation signal dCom is a digital signal for defining the waveform of the drive signal Com generated by the drive signal generation circuit 114.

When the recording processing is executed, the control circuit 170 first causes the storage circuit 160 to store the image data Img supplied from the processing apparatus 200. Next, the control circuit 170 generates various types of control signals such as the print signal SI, the waveform designation signal dCom, the control signal Sk1, the control signal Sk2, and the control signal Sk3 based on the image data Img stored in the storage circuit 160. Then, the control circuit 170 controls the liquid ejecting head HU such that the piezoelectric element 111f is driven as the transport mechanism 140 and the movement mechanism 130 are controlled to change the relative position of the medium PP with respect to the liquid ejecting head HU based on various types of control signals and various types of data stored in the storage circuit 160. Thereby, the control circuit 170 adjusts the presence or absence of ink ejection from the piezoelectric element 111f, the ejection amount of ink, the ejection timing of ink, or the like, and controls the execution of the recording processing for forming an image based on the image data Img on the medium PP.

Further, the ink jet printer 100 according to the present embodiment may execute ejection state determination processing for determining whether the ejection state of the ink from each of the nozzles Nz is normal or abnormal. Further, when an ejection failure is generated in the nozzle Nz included in the liquid ejecting head HU, it may be referred to as the ejection failure of the liquid ejecting head HU. In addition, the nozzle Nz in which the ejection failure is generated may be referred to as an “ejection failure nozzle Nz-T”. On the other hand, the nozzle Nz in which no ejection failure is generated may be referred to as a “normal ejection nozzle Nz-S”.

Here, the ejection failure is a state in which the ink cannot be ejected in the aspect defined by the drive signal Com although the piezoelectric element 111f is driven by the drive signal Com to eject the ink from the nozzle Nz and the ejection characteristic of the nozzle Nz is lowered. The ejection characteristic is, for example, one or both of the ejection amount and the ejection speed. Causes of the ejection failure include air bubbles mixed in the ink inside the liquid ejecting head HU, thickening of the ink of the liquid ejecting head HU, adhesion of paper dust to a nozzle surface FN of the liquid ejecting head HU, which will be described later, or the like. Here, the ejection aspect of the ink defined by the drive signal Com is that the piezoelectric element 111f ejects an amount of ink defined by the waveform of the drive signal Com, and the piezoelectric element 111f ejects the ink at an ejection speed defined by the waveform of the drive signal Com. That is, a state where the ink cannot be ejected according to the ejection aspect of ink defined by the drive signal Com includes a state where an amount of ink smaller than the ejection amount of ink defined by the drive signal Com is ejected from the nozzle Nz, a state where an amount of ink greater than the ejection amount of ink defined by the drive signal Com is ejected from the nozzle Nz, a state where the ink cannot land at a desired landing position on the medium PP because the ink is ejected at a speed different from the ejection speed of ink defined by the drive signal Com, or the like, in addition to a state where the ink cannot be ejected from nozzle Nz. In the following, the nozzle Nz that is a determination target of the ejection state may be referred to as a “determination target nozzle Nz-H”.

In the ejection state determination processing, the ink jet printer 100 executes a series of processing in which firstly, the control circuit 170 selects the determination target nozzle Nz-H from the 2M nozzles Nz, secondly, by driving the determination target nozzle Nz-H under the control of the control circuit 170, a residual vibration is caused to be generated in the pressure chamber CV communicating with the determination target nozzle Nz-H, thirdly, the detection circuit 117 generates a residual vibration signal NES based on the detection signal Vout detected from the piezoelectric element 111f that detects the residual vibration, and fourthly, the generation circuit 190 generates individual residual vibration information NEI on the residual vibration based on the residual vibration signal NES.

Further, the ink jet printer 100 according to the present embodiment executes maintenance processing for recovering the ejection failure of the nozzle Nz having the ejection failure by the maintenance mechanism 145. The maintenance processing includes flushing processing for discharging ink from the nozzle Nz, wiping processing for wiping off foreign matter such as paper dust adhering to the vicinity of the nozzle Nz with a wiper 147, and pumping processing for suctioning the ink, air bubbles, or the like in the nozzle Nz with a tube pump. The flushing processing is processing for forcibly removing thickened ink and air bubbles mixed in the ink by repeatedly driving the piezoelectric element 111f by using the drive signal Com for the flushing processing. The maintenance mechanism 145 includes a cap 146 to cover the liquid ejecting head HU such that the nozzle Nz is sealed, the wiper 147, a tube pump (not illustrated) to suck the ink, air bubbles, or the like, and a discharged ink receiving section (not illustrated) for receiving the discharged ink when the ink is discharged. The maintenance mechanism 145 is provided in a region that does not overlap with the medium PP when viewed in the Z-axis direction.

FIG. 6 is a cross-sectional view illustrating a configuration example of the head chip 111. Here, in FIG. 6, the drive circuit 112 is also illustrated in addition to the head chip 111. The head chip 111 has a configuration substantially symmetrical with each other in the direction along the X-axis. However, the positions of the nozzles Nz classified into the nozzle row La and the plurality of nozzles Nz of the nozzle row Lb in the direction along the Y-axis may coincide with each other or may be different from each other. FIG. 6 illustrates a configuration in which the positions of the plurality of nozzles Nz of the nozzle row La and the plurality of nozzles Nz of the nozzle row Lb in the direction along the Y-axis coincide with each other.

As illustrated in FIG. 6, the head chip 111 includes a flow path substrate 111a, a pressure chamber substrate 111b, a nozzle plate 111c, a vibration absorbing body 111d, a vibration plate 111e, the plurality of piezoelectric elements 111f, a protective plate 111g, a case 111h, and a wiring substrate 111i.

The flow path substrate 111a and the pressure chamber substrate 111b are stacked in this order in the Z1 direction, and form a flow path for supplying ink to the plurality of nozzles Nz. The vibration plate 111e, the plurality of piezoelectric elements 111f, the protective plate 111g, the case 111h, and the wiring substrate 111i are installed in a region positioned further in the Z1 direction with respect to the stacked body formed by the flow path substrate 111a and the pressure chamber substrate 111b. On the other hand, the nozzle plate 111c and the vibration absorbing bodies 111d are installed in a region positioned further in the Z2 direction with respect to the stacked body. Each element of the head chip 111 is schematically a plate-shaped member elongated in the Y direction, and is joined to each other by, for example, an adhesive. Hereinafter, each element of the head chip 111 will be described in order.

The nozzle plate 111c is a plate-shaped member provided with the plurality of nozzles Nz of each of the nozzle row La and the nozzle row Lb. Each of the plurality of nozzles Nz is a through hole through which ink passes. Here, the surface of the nozzle plate 111c facing the Z2 direction is the nozzle surface FN. The nozzle plate 111c is manufactured by processing a silicon single crystal substrate by a semiconductor manufacturing technique using a processing technique such as dry etching or wet etching. Here, other known methods and materials may be appropriately used for manufacturing the nozzle plate 111c. In addition, although the cross-sectional shape of the nozzle Nz is typically circular, the shape is not limited thereto and may be, for example, a non-circular shape such as polygonal and elliptical shapes.

A space R1, a plurality of supply flow paths Ra, and a plurality of communication flow paths Na are provided in the flow path substrate 111a for each of the nozzle row La and the nozzle row Lb. The space R1 is an elongated opening extending in the direction along the Y-axis in a plan view in the direction along the Z-axis. Each of the supply flow path Ra and the communication flow path Na is a through hole formed for each nozzle Nz. Each of the supply flow paths Ra communicates with the space R1.

The pressure chamber substrate 111b is a plate-shaped member in which a plurality of pressure chambers CV called cavities are provided for each of the nozzle row La and the nozzle row Lb. The plurality of pressure chambers CV are arranged in the direction along the Y-axis. Each pressure chamber CV is an elongated space formed for each nozzle Nz and extending in the direction along the X-axis in a plan view. Each of the flow path substrate 111a and the pressure chamber substrate 111b is manufactured by processing a silicon single crystal substrate by a semiconductor manufacturing technique, for example, in the same manner as the nozzle plate 111c described above. Here, other known methods and materials may be appropriately used for the manufacturing of each of the flow path substrate 111a and the pressure chamber substrate 111b.

The pressure chamber CV is a space positioned between the flow path substrate 111a and the vibration plate 111e. The plurality of pressure chambers CV are arranged in the direction along the Y-axis for each of the nozzle row La and the nozzle row Lb. In addition, the pressure chamber CV communicates with each of the communication flow path Na and the supply flow path Ra. Therefore, the pressure chamber CV communicates with the nozzle Nz through the communication flow path Na and communicates with the space R1 through the supply flow path Ra.

The vibration plate 111e is disposed on a surface of the pressure chamber substrate 111b facing the Z1 direction. The vibration plate 111e is a plate-shaped member that can elastically vibrate. The vibration plate 111e has, for example, a first layer and a second layer, which are stacked in the Z1 direction in this order. The first layer is, for example, an elastic film made of a silicon oxide (SiO₂). For example, the elastic film is formed by thermally oxidizing one surface of a silicon single crystal substrate. The second layer is, for example, an insulating film made of a zirconium oxide (ZrO₂). The insulating film is formed, for example, by forming a zirconium layer by a sputtering method and thermally oxidizing the layer. The vibration plate 111e is not limited to the above-mentioned stacked configuration of the first layer and the second layer, and may be composed of, for example, a single layer or three or more layers.

The plurality of piezoelectric elements 111f mutually corresponding to the nozzles Nz are disposed on a surface of the vibration plate 111e facing the Z1 direction for each of the nozzle row La and the nozzle row Lb. Each of the piezoelectric elements 111f is a passive element deformed by the drive signal Com being supplied. Each of the piezoelectric elements 111f has an elongated shape extending in the direction along the X-axis in a plan view. The plurality of piezoelectric elements 111f are arranged in the direction along the Y-axis to correspond to the plurality of pressure chambers CV. The piezoelectric element 111f overlaps the pressure chamber CV in a plan view.

FIG. 7 is an enlarged cross-sectional view illustrating the vicinity of the piezoelectric element 111f. However, in FIG. 7, the protective plate 111g is not illustrated such that the drawing is not complicated.

As illustrated in FIG. 7, the piezoelectric element 111f is a stacked body in which a piezoelectric body Zm is interposed between an upper electrode Zu to which the offset potential VBS is supplied and a lower electrode Zd to which the drive signal Com is supplied. The piezoelectric element 111f is, for example, a portion where the lower electrode Zd, the upper electrode Zu, and the piezoelectric body Zm overlap when viewed in the Z1 direction. In addition, the pressure chamber CV is provided in the Z2 direction of the piezoelectric element 111f. In the first embodiment, there is an aspect in which the offset potential VBS is supplied to the upper electrode Zu and the drive signal Com is supplied to the lower electrode Zd, but there may be an aspect in which the drive signal Com may be supplied to the upper electrode Zu, and the offset potential VBS may be supplied to the lower electrode Zd.

In the first embodiment, the lower electrode Zd is an individual electrode that is disposed to be separated from each other for each piezoelectric element 111f. On the other hand, the upper electrode Zu is a band-shaped common electrode that extends in the direction along the Y-axis to be continuous over the plurality of piezoelectric elements 111f. Examples of the metal material of the lower electrode Zd and the upper electrode Zu include metal materials such as platinum (Pt), aluminum (Al), nickel (Ni), gold (Au), and copper (Cu), and among these, one type can be used alone, or two or more types can be used in combination in an aspect of alloy or stacking or the like.

The piezoelectric body Zm is made of a piezoelectric material such as lead zirconate titanate (Pb(Zr, Ti)O₃) and, for example, has a band shape extending in the direction along the Y-axis to be continuous over the plurality of piezoelectric elements 111f. However, the piezoelectric body Zm may be integrated over the plurality of piezoelectric elements 111f. In this case, the piezoelectric body Zm is provided with through holes extending in the direction along the X-axis, penetrating through the piezoelectric layer in regions corresponding to the gaps between the respective pressure chambers CV adjacent to each other in a plan view. When the vibration plate 111e vibrates in conjunction with the above deformation of the piezoelectric elements 111f, the pressure in the pressure chamber CV fluctuates, and ink is ejected from the nozzle Nz.

The description returns to FIG. 6. The protective plate 111g is a plate-shaped member installed on the surface of the vibration plate 111e facing the Z1 direction, and protects the plurality of piezoelectric elements 111f and reinforces the mechanical strength of the vibration plate 111e. Here, the plurality of piezoelectric elements 111f are accommodated between the protective plate 111g and the vibration plate 111e. The protective plates 111g are made of, for example, a resin material.

The case 111h is a member for storing ink supplied to the plurality of pressure chambers CV. The case 111h is made of, for example, a resin material. The case 111h is provided with a space R2 for each of the nozzle row La and the nozzle row Lb. The space R2 is a space that communicates with the space R1 described above, and functions as a reservoir R for storing the ink supplied to the plurality of pressure chambers CV together with the space R1. The case 111h is provided with an introduction port IH for supplying ink to each of the reservoirs R. The ink in each of the reservoirs R is supplied to the pressure chamber CV through each of the supply flow paths Ra.

The vibration absorbing body 111d, also referred to as a compliance substrate, is a flexible resin film constituting a wall surface of the reservoir R, and absorbs pressure fluctuations of ink in the reservoir R. The vibration absorbing body 111d may be a thin plate made of metal and having flexibility. The surface of the vibration absorbing body 111d facing the Z1 direction is joined to the flow path substrate 111a with an adhesive or the like.

The wiring substrate 111i is mounted on the surface of the vibration plate 111e facing the Z1 direction, and is a mounting component for electrically coupling the head chip 111, the drive circuit 112, the control module CM, or the like. The wiring substrate 111i is, for example, a flexible wiring substrate such as COF, FPC, or FFC. The drive circuit 112 described above is mounted on the wiring substrate 111i of the present embodiment. COF is an abbreviation for Chip On Film. FPC is an abbreviation for Flexible Printed Circuit. FFC is an abbreviation for Flexible Flat Cable.

In the following, when it is assumed that n1 is a or b and m1 is any integer from 1 to M, the element related to the nozzle Nz[n1m1] may be described by adding [n1m1]. For example, the pressure chamber CV communicating with the nozzle Nz[n1m1] may be referred to as a pressure chamber CV[n1m1], and the piezoelectric element 111f that applies pressure to the pressure chamber CV[n1m1] may be referred to as a piezoelectric element 111f[n1m1]. Similarly, the elements related to the determination target nozzle Nz-H may be described by adding “-H”. For example, the pressure chamber CV communicating with the determination target nozzle Nz-H may be referred to as a “determination target pressure chamber CV-H”, and the piezoelectric element 111f that applies pressure to the determination target pressure chamber CV-H may be referred to as a “determination target piezoelectric element 111f-H”.

### 1-5. Configuration of Liquid Ejecting Head HU

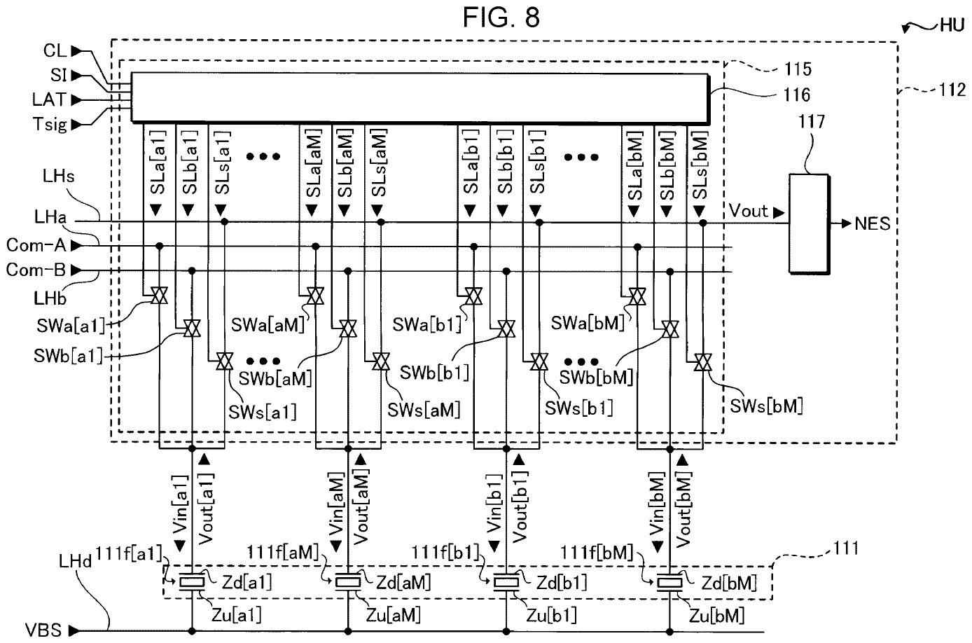

Hereinafter, a configuration of the liquid ejecting head HU will be described with reference to FIG. 8.

FIG. 8 is a block diagram illustrating an example of the configuration of the liquid ejecting head HU. FIG. 8 illustrates the head chip 111 and the drive circuit 112 provided in the liquid ejecting head HU.

In addition to the head chip 111 and the drive circuit 112, the liquid ejecting head HU includes an internal wiring LHa to which the drive signal Com-A is supplied from the drive signal generation circuit 114, an internal wiring LHb to which the drive signal Com-B is supplied from the drive signal generation circuit 114, an internal wiring LHs for supplying the detection signal Vout detected from the piezoelectric element 111f to the detection circuit 117, and an internal wiring LHd supplied with the offset potential VBS.

As illustrated in FIG. 8, the switching circuit 115 includes 2M switches SWa[a1] to SWa[bM], 2M switches SWb[a1] to SWb[bM], 2M switches SWs[a1] to SWs[bM], and a coupling state designation circuit 116 that designates the coupling state of each switch. As each switch, for example, a transmission gate can be employed.

The coupling state designation circuit 116 generates coupling state designation signals SLa[a1] to SLa[bM] for designating ON/OFF of the switches SWa[a1] to SWa[bM], coupling state designation signals SLb[a1] to SLb[bM] for designating ON/OFF of the switches SWb[a1] to SWb[bM], and coupling state designation signals SLs[a1] to SLs[bM] for designating ON/OFF of the switches SWs[a1] to SWs[bM] based on at least some of the print signal SI, a latch signal LAT, and a period designation signal Tsig supplied from the control circuit 170.

When n1 is a or b and m1 is any integer from 1 to M, the switch SWa[n1m1] switches conduction and non-conduction between the internal wiring LHa and the lower electrode Zd[n1m1] of the piezoelectric element 111f[n1m1] according to a coupling state designation signal SLa[n1m1]. For example, the switch SWa[n1m1] turns on when the coupling state designation signal SLa[n1m1] is at a high level, and turns off when it is at a low level.

When n1 is a or b and m1 is any integer from 1 to M, the switch SWb[n1m1] switches conduction and non-conduction between the internal wiring LHb and the lower electrode Zd[n1m1] of the piezoelectric element 111f[n1m1] according to the coupling state designation signal SLb[n1m1]. For example, the switch SWb[n1m1] turns on when the coupling state designation signal SLb[n1m1] is at a high level, and turns off when it is at a low level.

When n1 is a or b and m1 is any integer from 1 to M, a switch SWs[n1m1] switches conduction and non-conduction between the internal wiring LHs and the lower electrode Zd[n1m1] of the piezoelectric element 111f[n1m1] according to the coupling state designation signal SLs[n1m1]. For example, the switch SWs[n1m1] turns on when the coupling state designation signal SLs[n1m1] is at a high level, and turns off when it is at a low level.

When n1 is a or b and m1 is any integer from 1 to M, the detection circuit 117 is supplied with a detection signal Vout[n1m1] output from the piezoelectric element 111f[n1m1] through the internal wiring LHs. Then, the detection circuit 117 generates the residual vibration signal NES based on the detection signal Vout[n1m1]. The residual vibration signal NES is an analog signal.

The detection circuit 117 may be configured to include, for example, a negative feedback type amplifier for amplifying the detection signal Vout, a low-pass filter for attenuating the high frequency component of the detection signal Vout, and a voltage follower that converts impedance and outputs the residual vibration signal NES having a low impedance.

The generation circuit 190 generates the individual residual vibration information NEI on the residual vibration based on the residual vibration signal NES. The individual residual vibration information NEI is a digital signal. For example, the generation circuit 190 samples the residual vibration signal NES at regular intervals, and generates information in which the time information indicating the time of sampling based on any start point and the value indicating the potential obtained by sampling are associated with each other, as the individual residual vibration information NEI.

### 1-6. Operation of Liquid Ejecting Head HU

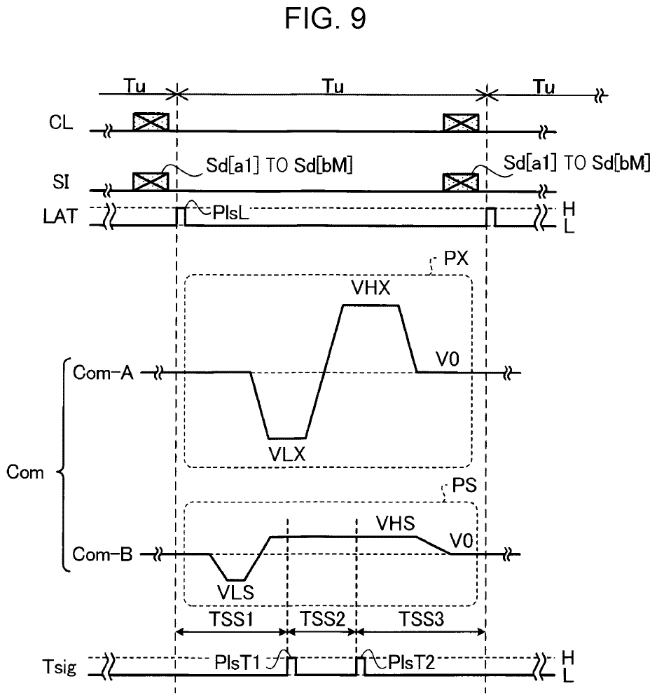

Hereinafter, the operation of the liquid ejecting head HU will be described with reference to FIG. 9. In the present embodiment, an operating period of the ink jet printer 100 includes one or more recording periods Tu. It is assumed that, in each of the recording periods Tu, the ink jet printer 100 according to the present embodiment executes one of the driving of each of the piezoelectric elements 111f in the recording processing and the driving of the determination target piezoelectric element 111f-H and the detection of the residual vibration in preparation processing of the ejection state determination processing. However, the present disclosure is not limited to such an aspect, and in each of the recording periods Tu, both the driving of each of the piezoelectric elements 111f in the recording processing and the driving of the determination target piezoelectric element 111f-H and the detection of the residual vibration in the preparation processing of the ejection state determination processing may be configured to be executed.

In general, the ink jet printer 100 forms an image based on the image data Img by ejecting the ink one or a plurality of times from each of the nozzles Nz over a plurality of continuous or intermittent recording periods Tu. In addition, in the 2M recording periods Tu provided continuously or intermittently, the ink jet printer 100 according to the present embodiment executes the ejection state determination processing in which each of the 2M nozzles Nz[a1] to Nz[bM] is defined as the determination target nozzle Nz-H by executing the preparation processing of the ejection state determination processing 2M times.

FIG. 9 is a timing chart for describing an operation of the ink jet printer 100 in the recording period Tu. As illustrated in FIG. 9, the control circuit 170 outputs the latch signal LAT having a pulse PlsL. Thereby, the control circuit 170 defines the recording period Tu as the period from the rise of the pulse PlsL to the rise of the next pulse PlsL.

The print signal SI includes individual designation signals Sd[a1] to Sd[bM] that designate the driving aspects of the piezoelectric elements 111f[a1] to 111f[bM] in each of the recording periods Tu. Then, when at least one of the recording processing and the ejection state determination processing is executed in the recording period Tu, as illustrated in FIG. 9, the control circuit 170 synchronizes the print signal SI including the individual designation signals Sd[a1] to Sd[bM] with a clock signal CL prior to the start of the recording period Tu and supplies the print signal SI to the coupling state designation circuit 116. In this case, when n1 is a or b and m1 is any integer from 1 to M, the coupling state designation circuit 116 generates the coupling state designation signals SLa[n1m1], SLb[n1m1], and SLs[n1m1] based on the individual designation signal Sd[n1m1] in the recording period Tu.

When n1 is a or b and m1 is any integer from 1 to M, the individual designation signal Sd[n1m1] according to the present embodiment is a signal that designates any one of the three driving aspects of ejection of ink, non-ejection of ink, and driving as a determination target in the ejection state determination processing, with respect to the piezoelectric element 111f[n1m1], in each of the recording periods Tu.

As illustrated in FIG. 9, the drive signal generation circuit 114 outputs the drive signal Com-A having an ejection waveform PX. The ejection waveform PX has a lowest potential VLX and a highest potential VHX. Potentials at the start and the end of the ejection waveform PX are set to a reference potential V0.

Then, on the assumption that n1 is a or b and m1 is any integer from 1 to M, when the individual designation signal Sd[n1m1] designates the ejection of ink for the piezoelectric element 111f[n1m1], the coupling state designation circuit 116 sets the coupling state designation signal SLa[n1m1] to a high level in the recording period Tu, and sets the coupling state designation signals SLb[n1m1] and SLs[n1m1] to a low level in the recording period Tu. In this case, the nozzle Nz[n1m1] ejects the ink in the recording period Tu, and dots are formed on the medium PP.

As illustrated in FIG. 9, the drive signal generation circuit 114 outputs the drive signal Com-B having an inspection waveform PS provided in the recording period Tu. In the present embodiment, the inspection waveform PS is defined such that the potential difference between a highest potential VHS and a lowest potential VLS of the inspection waveform PS is smaller than the potential difference between the highest potential VHX and the lowest potential VLX of the ejection waveform PX. Specifically, on the assumption that n1 is a or b and m1 is any integer from 1 to M, when the drive signal Com-B having the inspection waveform PS is supplied to the piezoelectric element 111f[n1m1], the inspection waveform PS is defined such that the piezoelectric element 111f[n1m1] is driven to such an extent that ink is not ejected from the nozzle Nz[n1m1]. Potentials at the start and end of the inspection waveform PS are set to the reference potential V0.

In addition, the control circuit 170 outputs the period designation signal Tsig having a pulse PlsT1 and a pulse PlsT2. Thereby, the control circuit 170 classifies the recording period Tu into a control period TSS1 from the start of the pulse PlsL to the start of the pulse PlsT1, a control period TSS2 from the start of the pulse PlsT1 to the start of the pulse PlsT2, and a control period TSS3 from the start of the pulse PlsT2 to the start of the next pulse PlsL.

Then, on the assumption that n1 is a or b and m1 is any integer from 1 to M, when the individual designation signal Sd[n1m1] designates the nozzle Nz[n1m1] as the determination target nozzle Nz-H, the coupling state designation circuit 116 sets the coupling state designation signal SLa[n1m1] to a low level in the recording period Tu, sets the coupling state designation signal SLb[n1m1] to a high level in the control periods TSS1 and TSS3 and to a low level in the control period TSS2, respectively, and sets the coupling state designation signal SLs[n1m1] to a low level in the control period TSS1 and the control period TSS3 and to a high level in the control period TSS2, respectively.

In this case, the determination target piezoelectric element 111f-H is driven by the drive signal Com-B having the inspection waveform PS in the control period TSS1. The piezoelectric element 111f is displaced by the drive signal Com-B having the inspection waveform PS in the control period TSS1. As a result, vibration is generated in the determination target pressure chamber CV-H, and this vibration remains even in the control period TSS2. Then, in the control period TSS2, the lower electrode Zd included in the determination target piezoelectric element 111f-H changes the potential according to the residual vibration generated in the determination target pressure chamber CV-H. In other words, in the control period TSS2, the lower electrode Zd included in the determination target piezoelectric element 111f-H indicates a potential corresponding to the electromotive force of the piezoelectric element 111f caused by the residual vibration generated in the determination target pressure chamber CV-H. Then, the potential of the lower electrode Zd can be detected as the detection signal Vout in the control period TSS2.

### 1-7. Cause of Ejection Failure

The liquid ejecting head HU includes electronic components such as the drive circuit 112, and thus deteriorates with age as the liquid ejecting head HU is used. In order to see this deterioration tendency, an aspect of analyzing the residual vibration can be considered. However, when the head manufacturer provides the printer manufacturer with the liquid ejecting head HU, in addition to the ejection failure caused by the liquid ejecting head HU, such as the deterioration with age, the ejection failure may be generated due to a cause other than the liquid ejecting head HU. The case where the ejection failure is generated due to a cause other than the liquid ejecting head HU is specifically a case where there is a problem in the transport mechanism 140 including the encoder and the transport roller, the medium PP is lifted, the interval between the liquid ejecting head HU and the medium PP is set to be narrower than a recommended interval, and the medium PP and the nozzle surface FN of the liquid ejecting head HU may collide with each other. As a result of the collision between the medium PP and the nozzle surface FN, a scratch may be generated in the nozzle Nz, and ink deposits may adhere to the vicinity of the nozzle Nz to cause the ejection failure.

The head manufacturer improves the liquid ejecting head HU to eliminate the ejection failure. In the case of the ejection failure generated by a cause caused by the liquid ejecting head HU, the head manufacturer can improve the ejection failure generated by the cause caused by the liquid ejecting head HU by modifying the liquid ejecting head HU. However, the ejection failure not caused by the liquid ejecting head HU is often not improved by the modification of the liquid ejecting head HU. Then, in the analysis of the residual vibration for viewing the deterioration with age, even the ejection failure not caused by the liquid ejecting head HU is determined as though it were the ejection failure caused by the liquid ejecting head HU. Therefore, the head manufacturer may not be able to appropriately improve the generated ejection failure as a result of attempting to improve the liquid ejecting head HU without noticing that the generated ejection failure is not the ejection failure caused by the liquid ejecting head HU. As described above, it is required to be able to accurately determine whether or not the abnormality is caused by the collision of the medium PP with the liquid ejecting head HU.

Since the intervals between the 2M nozzles Nz are extremely narrow, when the medium PP collides with the liquid ejecting head HU, there is a tendency that the ejection failure is generated in the plurality of continuous nozzles Nz, which is obtained by the inventors. Therefore, in the present embodiment, when the abnormality is detected in the plurality of continuous nozzles Nz, it is determined that the abnormality is generated due to the collision of the medium PP with the liquid ejecting head HU. In the present embodiment, the continuous nozzles Nz are referred to the nozzles Nz positioned in the direction of the nozzle row. Therefore, when m1 is an integer from 1 to M, the nozzles Nz continuous to the nozzle Nz[am1] classified into the nozzle row La are the J nozzles Nz from the nozzle Nz[am1+1] to the nozzle Nz[am1+J]. The value of J may be any value as long as it is an integer of 1 or greater and M or less, but is preferably 9 or greater.

In the following, the abnormality caused by the medium PP colliding with the liquid ejecting head HU may be referred to as a “medium collision abnormality”, and the abnormality of the liquid ejecting head HU caused by the liquid ejecting head HU may be referred to as a “pre-existing head abnormality”, such as mixing of air bubbles, thickening of ink, and leakage. The medium collision abnormality is an example of a “first abnormality”, and the pre-existing head abnormality is an example of a “second abnormality”.

### 1-8. Functions and Operations of Ink Jet System 10

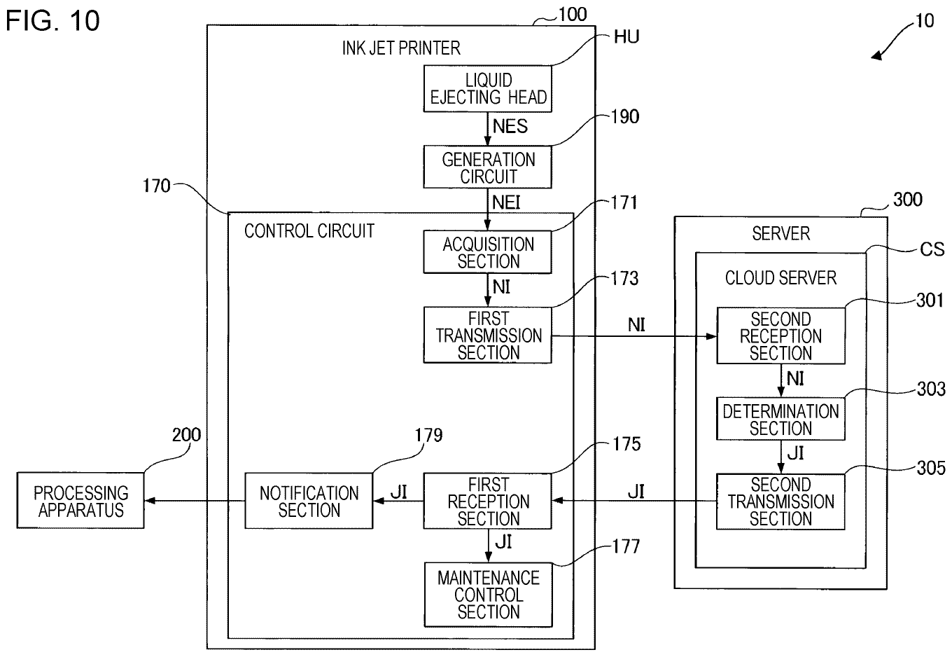

Functions and operations of the ink jet system 10 will be described with reference to FIGS. 10 to 13. In the present embodiment, the cloud server CS executes abnormality determination processing and provides the ink jet printer 100 with the service of providing determination information JI indicating a determination result. The abnormality determination processing is the processing for determining whether it is the medium collision abnormality, the pre-existing head abnormality, or a normal state in which neither the medium collision abnormality nor the pre-existing head abnormality is present, based on the residual vibration information NI having 2M pieces of the individual residual vibration information NEI.

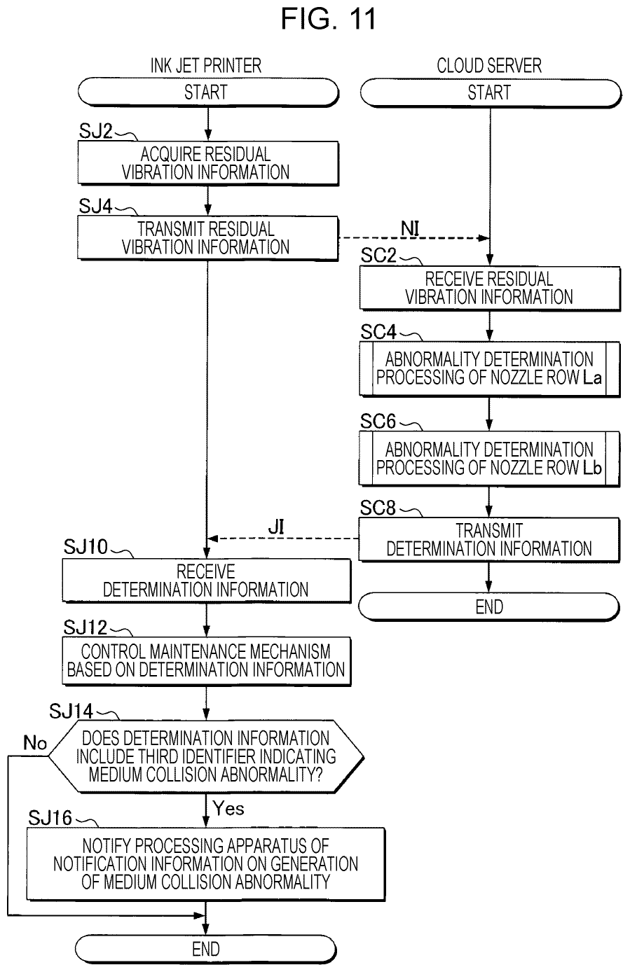

FIG. 10 is a diagram illustrating functions of the ink jet system 10. FIG. 11 is a flowchart illustrating operations of the ink jet system 10. The control circuit 170 reads the control program PM3 and executes the read control program PM3 to function as an acquisition section 171, a first transmission section 173, a first reception section 175, a maintenance control section 177, and a notification section 179. The server 300 reads the virtualization program VM and executes the read virtualization program VM to function as the cloud server CS. The cloud server CS reads the control program PM1 and executes the control program PM1 to function as a second reception section 301, a determination section 303, and a second transmission section 305.

The flowchart illustrated in FIG. 11 is executed, for example, when the ink jet printer 100 receives the image data Img from the processing apparatus 200, before the recording processing is executed. In a step SJ2, the control circuit 170 functions as the acquisition section 171 and acquires the residual vibration information NI. Specifically, the control circuit 170 acquires 2M pieces of the individual residual vibration information NEI corresponding to the 2M nozzles Nz, which are to be included in the residual vibration information NI, from the generation circuit 190. More specifically, the control circuit 170 sets the nozzle Nz[x] as the determination target nozzle Nz-H in each of x from a1 to bM, and executes the ejection state determination processing with respect to the determination target nozzle Nz-H to acquire the individual residual vibration information NEI[x]. The step SJ2 is an example of an “acquisition step”. After the processing of the step SJ2 is ended, in a step SJ4, the control circuit 170 functions as the first transmission section 173, controls the communication device 150, and transmits the residual vibration information NI having 2M pieces of the individual residual vibration information NEI acquired by the acquisition section 171 to the cloud server CS. More specifically, the first transmission section 173 transmits the residual vibration information NI to the cloud server CS via the processing apparatus 200. The step SJ4 is an example of a “transmission step”. After the processing of the step SJ4 is ended, the control circuit 170 waits for a response from the cloud server CS.

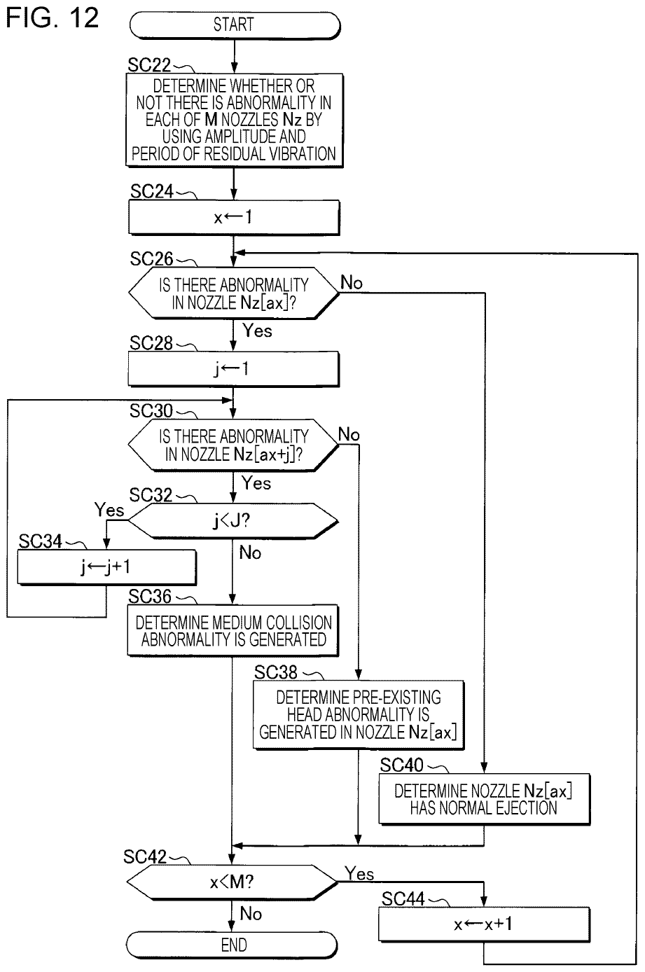

In a step SC2, the cloud server CS functions as the second reception section 301, and the cloud server CS receives the residual vibration information NI from the ink jet printer 100. After the processing of the step SC2 is ended, in a step SC4, the cloud server CS functions as the determination section 303 and executes the abnormality determination processing of the nozzle row La. The abnormality determination processing of the nozzle row La will be described with reference to FIG. 12.

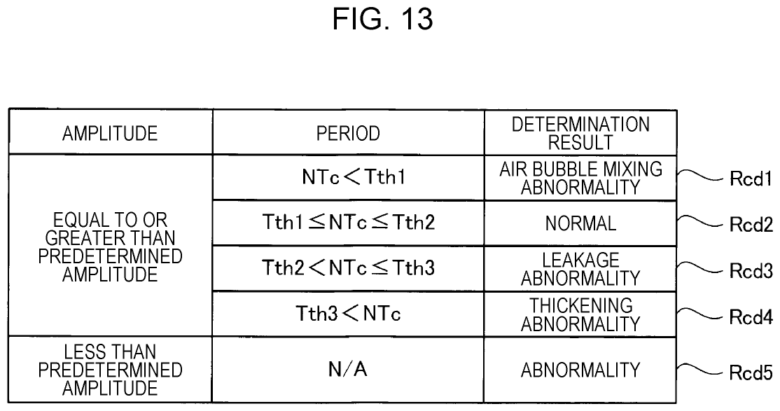

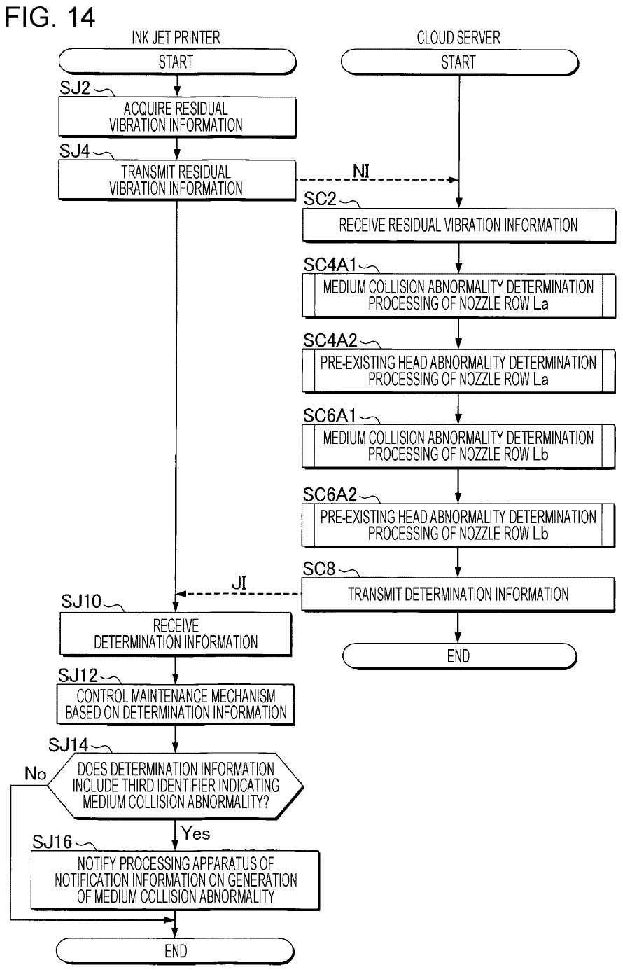

FIG. 12 is a flowchart illustrating the abnormality determination processing of the nozzle row La. In a step SC22, the determination section 303 determines whether or not there is an abnormality in each of the M nozzles Nz classified into the nozzle row La by using the amplitude and the period of the residual vibration. A method of determining whether or not the residual vibration with respect to the M nozzles Nz is abnormal will be described with reference to FIG. 13.

FIG. 13 is a diagram for describing a determination method of determining whether or not the residual vibration is abnormal. In general, the residual vibration generated in the pressure chamber CV has a natural vibration frequency determined by a shape of the nozzle Nz, a weight of an ink with which the pressure chamber CV is filled, a viscosity of the ink with which the pressure chamber CV is filled, or the like.

In addition, in general, when an abnormality is generated in an ejection state of the nozzle Nz since air bubbles are mixed in the nozzle Nz, a frequency of the residual vibration becomes higher as compared with a case where the air bubbles are not mixed in the nozzle Nz. In addition, in general, when a foreign matter such as paper dust adheres to the vicinity of the nozzle Nz and thus an abnormality is generated in the ejection state of the nozzle Nz, the frequency of the residual vibration becomes lower as compared with a case where the foreign matter does not adhere. For example, when the ink is leaked from the nozzle Nz and thus an abnormality is generated in the ejection state of the nozzle Nz, the frequency of the residual vibration becomes lower as compared with a case where the ink is not leaked from the nozzle Nz. In addition, in general, when the ink in the nozzle Nz is thickened and thus an abnormality is generated in the ejection state of the nozzle Nz, the frequency of the residual vibration becomes lower as compared with a case where the ink in the nozzle Nz is not thickened. In addition, in general, when the ink in the nozzle Nz is thickened and thus an abnormality is generated in the ejection state of the nozzle Nz, the frequency of the residual vibration becomes lower as compared with a case where a foreign matter such as paper dust adheres to the vicinity of the nozzle Nz. In addition, in general, when the pressure chamber CV is not filled with the ink and thus an abnormality is generated in the ejection state of the nozzle Nz, or when the piezoelectric element 111f is failed and cannot be displaced, and thus an abnormality is generated in the ejection state of the nozzle Nz, an amplitude of the residual vibration is reduced.

The individual residual vibration information NEI indicates a waveform corresponding to the residual vibration generated in the pressure chamber CV. Specifically, the residual vibration indicates a frequency corresponding to a frequency of the residual vibration generated in the pressure chamber CV as a detection target, and indicates an amplitude corresponding to an amplitude of the residual vibration generated in the pressure chamber CV.

The determination section 303 measures the time length of one period of the individual residual vibration information NEI as a period NTc of the individual residual vibration information NEI with respect to the one nozzle Nz among the M nozzles Nz. In addition, the determination section 303 determines whether or not the individual residual vibration information NEI has a predetermined amplitude. Specifically, the determination section 303 determines whether or not the potential of the individual residual vibration information NEI is equal to or higher than a first threshold value potential, which is a potential higher than the potential of the amplitude center level of the individual residual vibration information NEI, and is equal to or lower than a second threshold value potential, which is a potential lower than the potential of the amplitude center level, in the period in which the period NTc of the individual residual vibration information NEI is measured. Then, when the result of the determination is positive, it is specified that the individual residual vibration information NEI has a predetermined amplitude, and when the result of the determination is negative, it is specified that the individual residual vibration information NEI does not have a predetermined amplitude. Then, the determination section 303 determines whether or not there is an abnormality in the residual vibration based on the period NTc and the amplitude of the individual residual vibration information NEI.

A record Rcd1 to a record Rcd5 in FIG. 13 indicate the conditions of whether or not there is an abnormality in the residual vibration. For example, when the amplitude of the individual residual vibration information NEI is equal to or greater than a predetermined amplitude, the determination section 303 determines whether or not there is an abnormality in the residual vibration by comparing the period NTc of the individual residual vibration information NEI with some or all of threshold values Tth1, Tth2, and Tth3.

The threshold value Tth1 is a value for indicating a boundary between a time length of one period of the residual vibration when the ejection state of the nozzle Nz is normal and a time length of one period of the residual vibration when air bubbles are mixed in the pressure chamber CV. In addition, the threshold value Tth2 is a value for indicating a boundary between a time length of one period of the residual vibration when the ejection state of the nozzle Nz is normal and a time length of one period of the residual vibration when the foreign matter adheres to the vicinity of the nozzle Nz. In addition, the threshold value Tth3 is a value for indicating a boundary between the time length of one period of the residual vibration when the foreign matter adheres to the vicinity of the nozzle Nz and a time length of one period of the residual vibration when the ink in the pressure chamber CV is thickened. The threshold values Tth1, Tth2, and Tth3 satisfy “Tth1<Tth2<Tth3”.

As illustrated in the record Rcd5, in the present embodiment when, with respect to the one nozzle Nz[x] among the M nozzles Nz, the amplitude of the individual residual vibration information NEI[x] is equal to or greater than a predetermined amplitude and the period NTc of the individual residual vibration information NEI[x] satisfies “Tth1≤NTc≤Tth2” as illustrated in the record Rcd2, the determination section 303 determines that the nozzle Nz[x] is normal.

When, with respect to the one nozzle Nz[x], the amplitude of the individual residual vibration information NEI[x] is equal to or greater than a predetermined amplitude and the period NTc of the individual residual vibration information NEI[x] satisfies “NTc<Tth1” as illustrated in the record Rcd1, the determination section 303 determines that there is an air bubble mixing abnormality, which is caused by the mixing of air bubbles into the nozzle Nz, in the nozzle Nz[x]. In addition, when, with respect to the nozzle Nz[x], the amplitude of the individual residual vibration information NEI[x] is equal to or greater than a predetermined amplitude and the period NTc of the individual residual vibration information NEI satisfies “Tth2<NTc≤Tth3” as illustrated in the record Rcd3, the determination section 303 determines that there is a leakage abnormality, which is caused by the leakage of the ink from the nozzle Nz[x], in the nozzle Nz[x]. In addition, when the amplitude of the individual residual vibration information NEI[x] is equal to or greater than a predetermined amplitude and the period NTc of the individual residual vibration information NEI satisfies “Tth3<NTc” as illustrated in the record Rcd4, the determination section 303 determines that there is a thickening abnormality, which is caused by the thickening of the ink in the nozzle Nz, in the nozzle Nz[x].

When the amplitude of the individual residual vibration information NEI[x] is less than a predetermined amplitude, the determination section 303 determines that the nozzle Nz[x] is abnormal. In the first embodiment [x], when the amplitude of the individual residual vibration information NEI is less than a predetermined amplitude, the determination section 303 determines that there is an abnormality other than the above-described air bubble mixing abnormality, exposure abnormality, and thickening abnormality in the residual vibration.

The description will return to FIG. 12. After the processing of the step SC22 is ended, the determination section 303 substitutes 1 for a variable x in a step SC24. Next, in a step SC26, the determination section 303 determines whether or not there is an abnormality in the nozzle Nz[ax] with reference to the determination result in the step SC22. When the determination result in the step SC26 is positive, the determination section 303 substitutes 1 for a variable j in a step SC28. Next, in a step SC30, the determination section 303 determines whether or not there is an abnormality in the nozzle Nz[ax+j] with reference to the determination result in the step SC22.

When the determination result in the step SC30 is positive, the determination section 303 determines whether or not the value of the variable j is less than J in a step SC32.

When the determination result in the step SC32 is positive, the determination section 303 substitutes a value obtained by adding 1 to the value of the variable j for the variable j in a step SC34. After the processing of the step SC34 is ended, the determination section 303 returns the processing to the step SC30.

When the determination result in the step SC32 is negative, it indicates that there is an abnormality in the continuous J+1 nozzles Nz from the nozzle Nz[ax] to the nozzle Nz[ax+J]. Therefore, when the determination result in the step SC32 is negative, the determination section 303 determines that the medium collision abnormality is generated in a step SC36.

When the determination result in the step SC30 is negative, the determination section 303 determines that the pre-existing head abnormality is generated in the nozzle Nz[ax] in a step SC38. When the determination result in the step SC26 is negative, the determination section 303 determines that the nozzle Nz[ax] is in normal ejection in a step SC40.

After the processing of the step SC36 is ended, the determination section 303 determines whether or not the value of the variable x is less than M in a step SC42. After the processing of the step SC38 is ended and after the processing of the step SC40 is ended, the determination section 303 ends the processing of the step SC42. When the determination result in the step SC42 is positive, the determination section 303 substitutes a value obtained by adding 1 to the value of the variable x for the variable x in a step SC44. After the processing of the step SC44 is ended, the determination section 303 returns the processing to the step SC26. When the determination result in the step SC42 is negative, the determination section 303 ends the series of processing illustrated in FIG. 12.

When the value of x is greater than M−J, the value of x+j may exceed M in the step SC30. When the value of x+j exceeds M, the determination section 303 does not execute the processing of the step SC30, and executes the processing of the step SC38 on the assumption that the determination result in the step SC30 is negative.

The description will return to FIG. 11. After the processing of the step SC4 is ended, in a step SC6, the cloud server CS functions as the determination section 303 and executes the abnormality determination processing of the nozzle row Lb. The abnormality determination processing of the nozzle row Lb is omitted from illustration and description because the nozzle row to be the target of the abnormality determination processing of the nozzle row La is replaced with the nozzle row Lb. The cloud server CS may execute the processing of the step SC4 after executing the processing of the step SC6. In the following, the abnormality determination processing of the nozzle row La and the abnormality determination processing of the nozzle row Lb may be referred to as the abnormality determination processing without distinction. The step SC4 and the step SC6 are examples of the “determination step”.

After the processing of the step SC6 is ended, in a step SC8, the cloud server CS functions as the second transmission section 305, and transmits the determination information JI indicating the determination result of the determination section 303 to the ink jet printer 100. The determination information JI includes one or more identifiers among a first identifier indicating normality, a second identifier indicating that the pre-existing head abnormality is generated, and a third identifier indicating that the medium collision abnormality is generated. For example, when the processing of the step SC36 among the series of processing illustrated in FIG. 12 is executed, the determination information JI includes the third identifier. Further, when the processing of the step SC38 among the series of processing illustrated in FIG. 12 is executed, the determination information JI includes the second identifier. In addition, when the determination section 303 does not execute either the processing of the step SC36 or the processing of the step SC38, the determination information JI includes the first identifier. After the processing of the step SC8 is ended, the cloud server CS ends the series of processing illustrated in FIG. 11.

After the processing of the step SC8 is ended, the cloud server CS may store the determination information JI in the storage circuit 320. The head manufacturer can improve the liquid ejecting head HU by analyzing the determination information JI. In addition, in order to more efficiently improve the liquid ejecting head HU by the head manufacturer, the cloud server CS may store the residual vibration information NI and the determination information JI in association with each other in the storage circuit 320. Further, in order to reduce the usage capacity of the storage circuit 320, the cloud server CS may store the residual vibration information NI and the determination information JI in the storage circuit 320 in association with each other only when the determination information JI includes one or more identifiers among the second identifier and the third identifier.

After the processing of the step SJ4 is ended, the control circuit 170 waits for a response from the cloud server CS, and in a step SJ10, the control circuit 170 functions as the first reception section 175 to receive the determination information JI from the cloud server CS. The step SJ10 is an example of a “reception step”. After the processing of the step SJ10 is ended, in a step SJ12, the control circuit 170 functions as the maintenance control section 177, and controls the maintenance mechanism 145 based on the determination information JI to eliminate the pre-existing head abnormality.

For example, when the determination information JI includes an identifier indicating the air bubble mixing abnormality, the maintenance control section 177 causes the maintenance mechanism 145 to execute the pumping processing. In addition, when the determination information JI includes an identifier indicating the leakage abnormality, the maintenance control section 177 causes the maintenance mechanism 145 to execute the wiping processing. In addition, when the determination information JI includes an identifier indicating the thickening abnormality, the maintenance control section 177 causes the maintenance mechanism 145 to execute the flushing processing or the pumping processing.

After the processing of the step SJ12 is ended, in a step SJ14, the control circuit 170 determines whether or not the determination information JI includes the third identifier indicating the medium collision abnormality. When the determination result in the step SJ14 is positive, in a step SJ16, the control circuit 170 functions as the notification section 179 and transmits the notification information on the generation of the medium collision abnormality to the processing apparatus 200. The notification information is, for example, a first character string indicating that the medium collision abnormality is generated. The first character string is, for example, “There may be a collision of the printing paper with the liquid ejecting head”. Further, the notification information may include a second character string indicating an example of a user U's countermeasure when the medium collision abnormality is generated. The second character string is, for example, “It is recommended to modify the setting of the transport mechanism and the setting of the interval between the liquid ejecting head and the printing paper”. When the notification information is received, the processing apparatus 200 displays the character string indicated by the notification information on the display device 270. The notification information is not limited to the character string indicating that the medium collision abnormality is generated, and may include one or both of information indicating an image indicating that the medium collision abnormality is generated and information indicating a voice indicating that the medium collision abnormality is generated.

The control circuit 170 may execute the processing of the step SJ14 and the processing of the step SJ16 before the processing of the step SJ12.

After the processing of the step SJ16 is ended, or when the determination result in the step SJ14 is negative, the control circuit 170 ends the series of processing illustrated in FIG. 11.

### 1-9. Summary of First Embodiment

Hereinafter, in order to facilitate understanding, the individual residual vibration information NEI on the residual vibration in the pressure chamber CV communicating with the target nozzle Nz among the 2M nozzles Nz is referred to as “first individual information”, and J pieces of the individual residual vibration information NEI on the J residual vibrations in the respective J pressure chambers CV respectively communicating with the J nozzles Nz, in which J is equal to or greater than 1, continuous to the target nozzle Nz is referred to as “second individual information”, to describe the summary of the first embodiment.

As described above, in the first embodiment, a control method of the ink jet printer 100 that includes the liquid ejecting head HU having the 2M piezoelectric elements 111f, the 2M pressure chambers CV applying pressure to the internal ink by driving the piezoelectric elements 111f, and the 2M nozzles Nz which respectively communicate with the 2M pressure chambers CV and from which the ink is ejected, and that ejects the ink onto the medium PP, is defined. This control method performs the processing of the step SJ2 of acquiring the residual vibration information NI on the residual vibration in the pressure chamber CV after applying the voltage to the one or more piezoelectric elements 111f among the 2M piezoelectric elements 111f, and the processing of the step SC6 and the processing of the step SC8 of determining whether or not the medium collision abnormality, which is an abnormality caused by the collision of the medium PP with the liquid ejecting head HU, is generated based on the residual vibration information NI.

According to the first embodiment, whether or not the medium collision abnormality is generated can be accurately determined by using a tendency that the ejection failure tends to be generated in the continuous plurality of nozzles Nz when the medium PP collides with the liquid ejecting head HU. For example, when the medium collision abnormality is generated, the head manufacturer can reduce the load due to the improvement of the liquid ejecting head HU of the head manufacturer, because the head manufacturer does not have to investigate the cause for the improvement of the liquid ejecting head HU. In addition, the ink jet printer 100 can notify the printer manufacturer or the user U that the medium collision abnormality is generated. When the printer manufacturer or the user U is aware that the medium collision abnormality is generated, the medium collision abnormality can be suppressed from being generated again by setting the interval between the liquid ejecting head HU and the medium PP to be appropriately maintained.

The residual vibration information NI has the first individual information and the second individual information, and the determination section 303 determines that the medium collision abnormality is generated when the abnormality is detected in all of the residual vibration related to the first individual information and the J residual vibrations related to the second individual information in the processing of the step SC6 and the processing of the step SC8.

As described above, when the abnormality is detected in the continuous J+1 nozzles Nz, the abnormality is highly likely to be caused by the collision of the medium PP with the liquid ejecting head HU. Therefore, when the abnormality is detected in the continuous J+1 nozzles Nz, it is determined that the medium collision abnormality is generated, so that whether or not the medium collision abnormality is generated can be accurately determined.

In addition, in the processing of the step SC4 and the processing of the step SC6, when an abnormality in the residual vibration related to the first individual information is detected, and an abnormality in any of the J residual vibrations related to the second individual information is not detected, the determination section 303 determines that the medium collision abnormality is not generated.

Although an abnormality is detected in the target nozzle Nz, when an abnormality is not generated in the nozzles Nz continuous to the target nozzle Nz, only the pre-existing head abnormality is generated in the target nozzle Nz, and it is highly likely that the medium PP does not collide with the liquid ejecting head HU. Therefore, when an abnormality is not generated in the nozzles Nz continuous to the target nozzle Nz, whether or not the medium collision abnormality is generated can be accurately determined by determining that the medium collision abnormality is not generated.

In addition, the J nozzles Nz are the nine or more nozzles Nz.

The intervals between the 2M nozzles Nz are extremely narrow. For example, when the resolution of the image formed by the M nozzles Nz classified into one nozzle row is 300 dpi, the interval between the two nozzles Nz is 25.4 mm/300 , which is substantially 0.085 mm. Therefore, when the medium PP collides with the liquid ejecting head HU, it is highly likely that the ejection failure is generated in the many continuous nozzles Nz. On the other hand, the pre-existing head abnormality may be generated in the two or three continuous nozzles Nz among the 2M nozzles Nz. Therefore, when the J nozzles Nz are the three nozzles Nz, it is highly likely that it is erroneously determined that the medium collision abnormality is generated although the medium PP does not collide with the liquid ejecting head HU. Therefore, according to the first embodiment, the determination accuracy of whether or not the medium collision abnormality is generated can be improved as compared with the aspect in which the J nozzles Nz are less than the nine nozzles Nz.

In addition, the determination section 303 further determines whether or not the pre-existing head abnormality, which is an abnormality different from the medium collision abnormality and is an abnormality of the liquid ejecting head HU caused by the liquid ejecting head HU, is generated based on the first individual information in the processing of the step SC6 and the processing of the step SC8.

According to the first embodiment, whether or not the medium collision abnormality is generated can be accurately determined as whether or not the pre-existing head abnormality is generated is determined.

In addition, in the processing of the step SC6 and the processing of the step SC8, when an abnormality from the residual vibration related to the first individual information is detected, and an abnormality in any of the J residual vibrations related to the second individual information is not detected, the determination section 303 determines that the pre-existing head abnormality is generated.

When an abnormality is not detected in any of the J residual vibrations related to the second individual information, it means that an abnormality is not generated in the continuous nozzles Nz, and in the nozzle Nz in which the abnormality is detected, it means that the pre-existing head abnormality is generated. Therefore, according to the first embodiment, when no abnormality is detected in any of the J residual vibrations related to the second individual information, the determination accuracy of whether or not the pre-existing head abnormality is generated can be improved by determining that the pre-existing head abnormality is generated.

The control method of the ink jet printer 100 uses the cloud server CS provided outside the ink jet printer 100. The control method further performs the processing of the step SJ4 of transmitting the residual vibration information NI from the ink jet printer 100 to the cloud server CS when the residual vibration information NI is acquired by the processing of the step SJ2 and the processing of the step SJ10 of receiving the determination information JI indicating the determination result by the determination section 303 from the cloud server CS, and the cloud server CS performs the abnormality determination processing as the determination section 303. In other words, the cloud server CS executes the abnormality determination processing and provides the ink jet printer 100 with the service that provides the determination information JI indicating the determination result.

The service that provides the determination information JI may be provided for a limited period. In addition, an aspect in which the ink jet printer 100 performs the abnormality determination processing is also possible. Therefore, as an aspect of providing the service that provides the determination information JI to the printer manufacturer for a limited period, an aspect is considered in which the ink jet printer 100 performs the abnormality determination processing. However, in the aspect in which the ink jet printer 100 performs the abnormality determination processing, the program for performing the abnormality determination processing is stored in the storage circuit 160, so that as a result of the printer manufacturer improperly analyzing the program for performing the abnormality determination processing, there is a risk that the printer manufacturer independently realizes the abnormality determination processing by using the improperly analyzed result after the period in which the service that provides the determination information JI is provided is expired. In the first embodiment, since the main body that executes the abnormality determination processing is the cloud server CS, the leakage of the program for executing the abnormality determination processing can be suppressed as the service that provides the determination information JI to the printer manufacturer is provided for a limited period.

### 2. Second Embodiment

In the first embodiment, the determination section 303 determines whether or not the medium collision abnormality is generated and whether or not the pre-existing head abnormality is generated by using the amplitude and the period of the residual vibration, but the present disclosure is not limited thereto. In the second embodiment, the determination section 303 determines whether or not the medium collision abnormality is generated by using the amplitude of the residual vibration, and determines whether or not the pre-existing head abnormality is generated by using the amplitude and the period of the residual vibration. Hereinafter, the second embodiment will be described.

### 2-1. Functions and Operations of Ink Jet System 10 in Second Embodiment

FIG. 14 is a flowchart illustrating operations of the ink jet system 10 according to the second embodiment. The flowchart illustrated in FIG. 14 is different from the flowchart illustrated in FIG. 11 in that the processing of a step SC4A1 and the processing of a step SC4A2 are executed instead of the processing of the step SC4, and the processing of a step SC6A1 and the processing of a step SC6A2 are executed instead of the processing of the step SC6, and is the same as the flowchart illustrated in FIG. 11 in other respects. Hereinafter, only differences from the flowchart illustrated in FIG. 11 will be described.

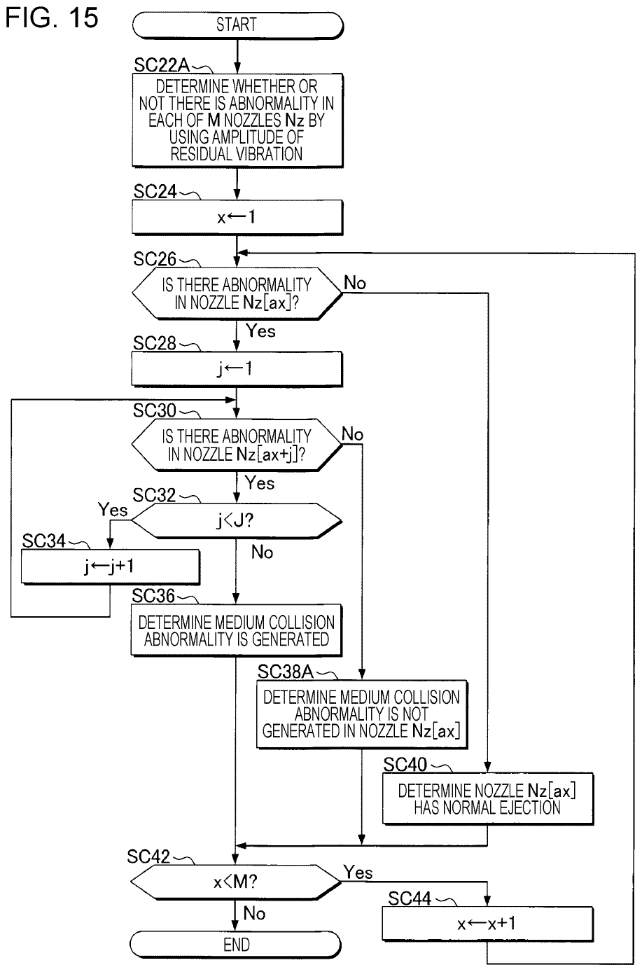

After the processing of the step SC2 is ended, the cloud server CS functions as the determination section 303 and executes the medium collision abnormality determination processing of the nozzle row La in the step SC4A1. The medium collision abnormality determination processing of the nozzle row La will be described with reference to FIG. 15.

FIG. 15 is a flowchart illustrating the medium collision abnormality determination processing of the nozzle row La. The flowchart illustrated in FIG. 15 is different from the flowchart illustrated in FIG. 12 in that the processing of a step SC22A is executed instead of the processing of the step SC22, and the processing of a step SC38A is executed instead of the processing of the step SC38, and is the same as the flowchart illustrated in FIG. 12 in other respects. Hereinafter, only differences from the flowchart illustrated in FIG. 12 will be described.

In the step SC22A, the determination section 303 determines whether or not there is an abnormality in each of the M nozzles Nz classified into the nozzle row La by using the amplitude of the residual vibration without using the period of the residual vibration. For example, when the amplitude of the residual vibration corresponding to the one nozzle Nz among the M nozzles Nz is less than a predetermined amplitude, the determination section 303 determines that the one nozzle Nz is abnormal.

When the determination result in the step SC30 is negative, the determination section 303 determines that the medium collision abnormality is not generated in the nozzle Nz[ax] in the step SC38A.

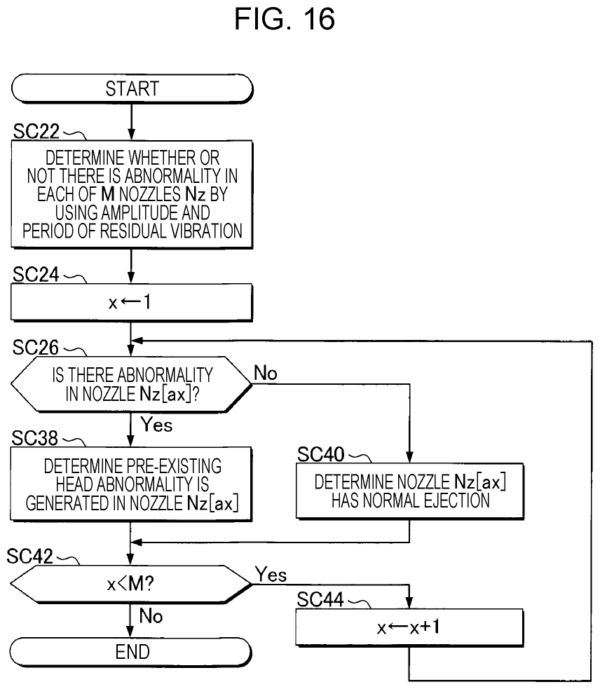

The description will return to FIG. 14. After the processing of the step SC4A1 is ended, the cloud server CS functions as the determination section 303 and executes the pre-existing head abnormality determination processing of the nozzle row La in the step SC4A2. The pre-existing head abnormality determination processing of the nozzle row La will be described with reference to FIG. 16.

FIG. 16 is a flowchart illustrating the pre-existing head abnormality determination processing of the nozzle row La. The flowchart illustrated in FIG. 16 is different from the flowchart illustrated in FIG. 12 in that, when the determination result in the step SC26 is positive, the processing of the step SC38 is executed and the processing of the step SC28, the processing of the step SC30, the processing of the step SC32, the processing of the step SC34, and the processing of the step SC36 are not executed, and is the same as the flowchart illustrated in FIG. 12 in other respects. Since each processing illustrated in FIG. 16 is the same as any one of the series of processing illustrated in FIG. 12, the description thereof will be omitted.

The description will return to FIG. 14. After the processing of the step SC4A2 is ended, the cloud server CS functions as the determination section 303 and executes the medium collision abnormality determination processing of the nozzle row Lb in the step SC6A1. The medium collision abnormality determination processing of the nozzle row Lb is omitted from illustration and description because the nozzle row to be the target of the medium collision abnormality determination processing of the nozzle row La is replaced with the nozzle row Lb. After the processing of the step SC6A1 is ended, the cloud server CS functions as the determination section 303 and executes the pre-existing head abnormality determination processing of the nozzle row Lb in the step SC6A2. The pre-existing head abnormality determination processing of the nozzle row Lb is omitted from illustration and description because the nozzle row to be the target of the pre-existing head abnormality determination processing of the nozzle row La is replaced with the nozzle row Lb. In the second embodiment, the step SC4A1, the step SC4A2, the step SC6A1, and the step SC6A2 are examples of the “determination step”. After the processing of the step SC6A2 is ended, the cloud server CS executes the processing of the step SC8.

### 2-2. Summary of Second Embodiment

Hereinafter, in order to facilitate understanding, the individual residual vibration information NEI on the residual vibration in the pressure chamber CV communicating with the target nozzle Nz among the 2M nozzles Nz is referred to as “first individual information”, and J pieces of the individual residual vibration information NEI on the J residual vibrations in the respective J pressure chambers CV respectively communicating with the J nozzles Nz, in which J is equal to or greater than 1, continuous to the target nozzle Nz is referred to as “second individual information”, to describe the summary of the second embodiment.

In the processing of the step SC4A1 and the processing of the step SC6A1, the determination section 303 determines whether or not the medium collision abnormality is generated by using the amplitude of the residual vibrations related to the first individual information and the second individual information and without using the period of the residual vibrations related to the first individual information and the second individual information.

When the medium PP collides with the liquid ejecting head HU, and as a result, a scratch is generated in the nozzle Nz or ink deposits adhere to the vicinity of the nozzle Nz, there is a tendency that the ink is not ejected although the drive signal Com is applied to the piezoelectric element 111f. The amplitude of the residual vibration when the ink is not ejected tends to be smaller than the amplitude of the residual vibration assumed by the head manufacturer. Therefore, in determining whether or not the medium collision abnormality is generated, it is sufficient to use only the amplitude of the residual vibration without using the period of the residual vibration. Therefore, according to the second embodiment, as compared with the aspect in which the medium collision abnormality determination processing is executed by using the amplitude and the period of the residual vibration, the determination accuracy of whether or not the medium collision abnormality is generated can be maintained as the processing amount required for determining whether or not the medium collision abnormality is generated is reduced.

In the processing of the step SC4A2 and the processing of the step SC6A2, the determination section 303 determines whether or not the pre-existing head abnormality is generated by using the amplitude and the period of the residual vibrations related to the first individual information and the second individual information.

As illustrated in FIG. 13, when the pre-existing head abnormality is generated, one or a plurality of abnormalities of the mixing of air bubbles, the thickening of ink, and the leakage are generated, and whether one or a plurality of abnormalities of the mixing of air bubbles, the thickening of ink, and the leakage are generated can be accurately determined by using the amplitude and the period of the residual vibration. In addition, the maintenance control section 177 needs to cause the maintenance mechanism 145 to execute processing according to each abnormality to eliminate the mixing of air bubbles, the thickening of ink, and the leakage. Therefore, it is preferable that whether one or a plurality of abnormalities among the mixing of air bubbles, the thickening of ink, and the leakage are generated can be accurately determined. According to the second embodiment, whether one or plurality of abnormalities of the mixing of air bubbles, the thickening of ink, and the leakage are generated can be accurately determined, as compared with the aspect of executing the pre-existing head abnormality processing by using the amplitude of the residual vibration without using the period of the residual vibration, so that the likelihood that the pre-existing head abnormality is eliminated can be improved.

### 3. Modification Example

Each of the above-described aspects can be variously modified. Specific aspects of modification that can be applied to each of the above-described aspects will be described below. Two or more aspects optionally selected from the following examples can be appropriately merged to the extent that they do not contradict each other.

### 3-1. First Modification Example

When the ink jet printer 100 cannot be temporarily connected to the cloud server CS, the ink jet printer 100 stores the residual vibration information NI in the storage circuit 160 of the ink jet printer 100. Hereinafter, the first modification example will be described.

### 3-1-1. Operation of First Modification Example

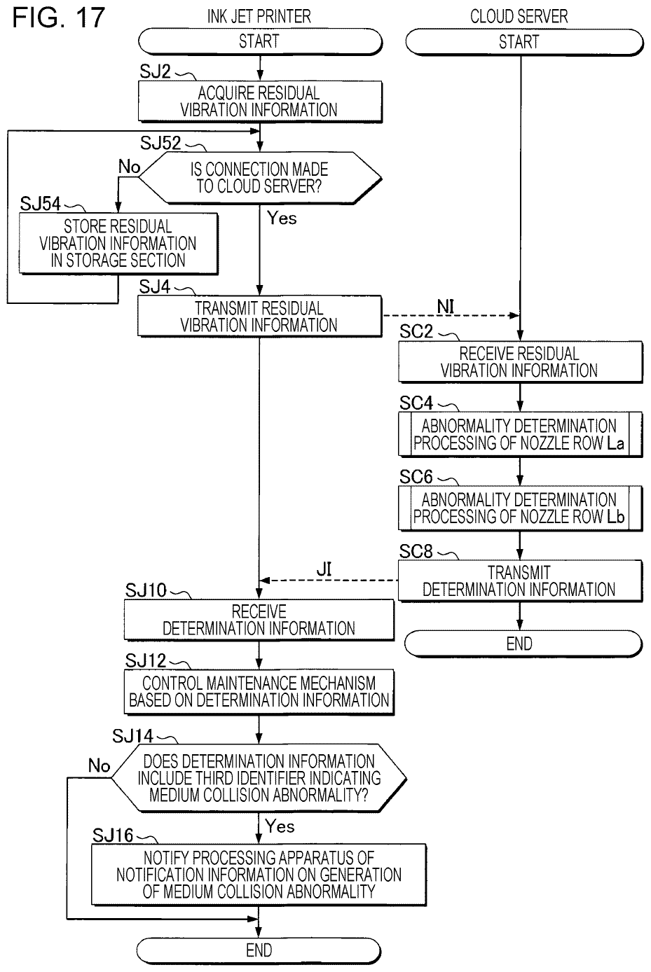

FIG. 17 is a flowchart illustrating operations of the ink jet system 10 according to the first modification example. The flowchart illustrated in FIG. 17 is different from the flowchart illustrated in FIG. 11 in that the processing of a step SJ52 and the processing of a step SJ54 are executed between the processing of the step SJ2 and the processing of the step SJ4, and is the same as the flowchart illustrated in FIG. 11 in other respects. Hereinafter, only differences from the flowchart illustrated in FIG. 11 will be described.

After the processing of step SJ2 is ended, in step SJ52, the control circuit 170 functions as the first transmission section 173 and determines whether or not connection is made to the cloud server CS. When the determination result in the step SJ52 is negative, in the step SJ54, the control circuit 170 causes the storage circuit 160 to store the residual vibration information NI acquired in the step SJ2. The storage circuit 160 is an example of a “storage section”. After the processing of the step SJ54 is ended, the control circuit 170 executes the processing of the step SJ52 again. When the determination result in the step SJ52 is positive, the control circuit 170 executes the processing in the step SJ4. In the processing of the step SJ4, when the processing of the step SJ54 is executed, the control circuit 170 transmits the residual vibration information NI stored in the storage circuit 160 to the cloud server CS.

Although not illustrated in FIG. 17, the processing of the step SJ54 may be executed only once at the beginning. In addition, when a case where the determination result of the step SJ52 is negative is performed a plurality of times, the control circuit 170 may end the series of processing illustrated in FIG. 17. Then, the control circuit 170 transmits information indicating that the residual vibration information NI cannot be transmitted to the cloud server CS to the processing apparatus 200. The processing apparatus 200 displays, on the display device 270, a dialog indicating that the residual vibration information NI cannot be transmitted to the cloud server CS and prompting the user U to select whether or not to execute the recording processing of the image data Img in the ink jet printer 100. When the user U selects the recording processing to be executed by the ink jet printer 100, the ink jet printer 100 executes the recording processing.

In addition, as illustrated in FIG. 5, the ink jet printer 100 includes the storage circuit 160 in the printer main body, but the liquid ejecting head HU may include the storage circuit. Then, the control circuit 170 may store the residual vibration information NI in the storage circuit of the liquid ejecting head HU in the step SJ54.

### 3-1-2. Summary of First Modification Example

In the above description, in the first modification example, the ink jet printer 100 is provided with the storage circuit 160, and the first transmission section 173 stores the residual vibration information NI acquired by the processing of the step SJ2 in the storage circuit 160 when the ink jet printer 100 and the cloud server CS are unable to be connected to each other in the step SJ54.

The ink jet printer 100 and the cloud server CS may be temporarily unable to be connected to each other due to reasons such as temporary interruption of the service of the cloud server CS or communication congestion between the ink jet printer 100 and the cloud server CS. According to the first modification example, although the ink jet printer 100 and the cloud server CS are unable to be connected to each other, when the residual vibration information NI is stored in the storage circuit 160, the residual vibration information NI can be transmitted to the cloud server CS when the ink jet printer 100 and the cloud server CS are connected.

### 3-2. Second Modification Example

In each of the above-described aspects, the cloud server CS functions as the determination section 303, but the control circuit 170 may function as the determination section 303.

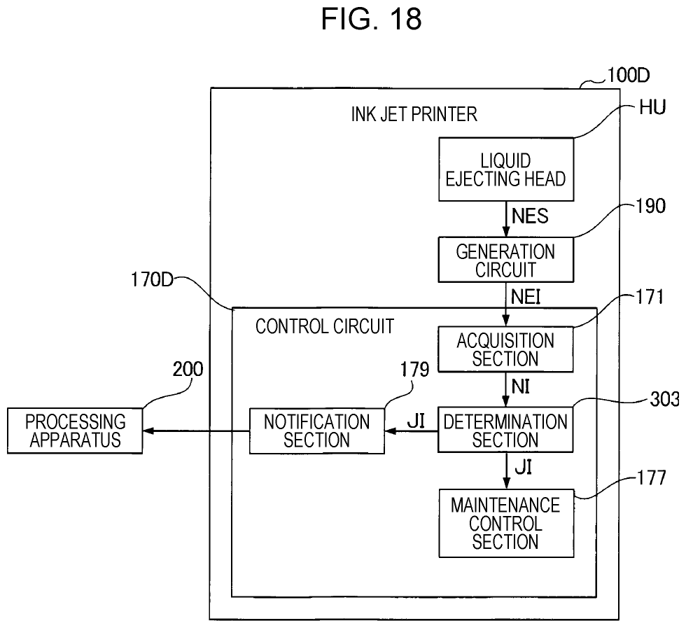

FIG. 18 is a diagram illustrating functions of an ink jet printer 100D according to the second modification example. The ink jet printer 100D is different from the ink jet printer 100 in that a control circuit 170D is provided instead of the control circuit 170. The control circuit 170D is different from the control circuit 170 in that the control circuit 170D functions as the acquisition section 171, the determination section 303, the maintenance control section 177, and the notification section 179. That is, the control circuit 170D functions as the determination section 303 and performs the processing of the step SC4 and the processing of the step SC6.

According to the second modification example, the control circuit 170D performs the processing of the step SC4, so that the speed of obtaining the determination information JI can be improved by not having to execute the transmission of the residual vibration information NI and the reception of the determination information JI as compared with the ink jet system 10 in the first embodiment. For example, when the head manufacturer manufactures a printer main body in addition to the liquid ejecting head HU, the second modification example may be applied.

In the second modification example, the control circuit 170D performs the processing of the step SC4 and the processing of the step SC6, but the control circuit 170D may transmit the residual vibration information NI to the processing apparatus 200, and the control circuit 210 of the processing apparatus 200 may perform the processing of the step SC4 and the processing of the step SC6.

In the second modification example, after the control circuit 170D performs the processing of the step SC4 and the processing of the step SC6, the control circuit 170D may transmit the determination information JI to the cloud server CS. When the determination information JI is received, the cloud server CS stores the determination information JI in the storage circuit 320. In addition, the control circuit 170D may transmit the residual vibration information NI and the determination information JI to the cloud server CS. When the cloud server CS receives the residual vibration information NI and the determination information JI, the cloud server CS associates the residual vibration information NI with the determination information JI and stores the residual vibration information NI and the determination information JI in the storage circuit 320. In addition, the control circuit 170D may transmit the residual vibration information NI and the determination information JI to the cloud server CS only when the determination information JI includes one or more identifiers among the second identifier and the third identifier.

In addition, the ink jet printer 100D according to the second modification example may not be connected to the cloud server CS. When a service support person of the head manufacturer visits the printer manufacturer or the user U, the ink jet printer 100D or the processing apparatus 200 copies the determination information JI or the like to the portable storage device brought by the service support person. The portable storage device is, for example, an SSD. SSD is an abbreviation for Solid State Drive. Then, when the service support person returns to the business office of the head manufacturer, the PC that is connectable to the cloud server CS transmits the determination information JI or the like stored in the portable storage device to the cloud server CS.

### 3-3. Third Modification Example

In each of the above-described aspects, the cloud server CS determines whether or not the pre-existing head abnormality is generated based on the residual vibration information NI, in addition to whether or not the medium collision abnormality is generated, but the present disclosure is not limited thereto. For example, the cloud server CS may determine only whether or not the medium collision abnormality is generated based on the residual vibration information NI, and may not determine whether or not the pre-existing head abnormality is generated.

### 3-4. Fourth Modification Example

In each of the above-described aspects, the cloud server CS acquires the residual vibration information NI having the 2M pieces of the individual residual vibration information NEI, but the present disclosure is not limited thereto. The cloud server CS may acquire the residual vibration information NI having two or more pieces of the individual residual vibration information NEI out of 2M pieces, and may determine whether or not the medium collision abnormality is generated based on the residual vibration information NI.

### 3-5. Fifth Modification Example

In each of the above-described aspects, when the ink jet printer 100 is connectable to the network NW, the communication device 150 is connected to the network NW, but the present disclosure is not limited thereto. For example, when the liquid ejecting head HU includes a communication device, the communication device may communicate with the network NW.

### 3-6. Sixth Modification Example

In each of the above aspects, the individual residual vibration information NEI is information in which the time information and the potential value are associated with each other, but the individual residual vibration information NEI is not limited to information in which the time information and the potential value are associated with each other. For example, the individual residual vibration information NEI may be one value or both values of a value indicating the amplitude of the residual vibration and a value indicating the period of the residual vibration. For example, the generation circuit 190 specifies the amplitude of the residual vibration from the residual vibration signal NES, and outputs a value indicating the specified amplitude as the individual residual vibration information NEI to the control circuit 170.

### 3-7. Seventh Modification Example

In each of the above-described aspects, J is described as 9, but the present disclosure is not limited thereto. For example, when the resolution of the image formed by the M nozzles Nz classified into the nozzle row included in the liquid ejecting head HU is high, the determination accuracy of whether or not the medium collision abnormality is generated can be improved by increasing the number J.

### 3-8. Eighth Modification Example

In each of the above-described aspects, the serial type ink jet printer 100 in which the liquid ejecting head HU is reciprocated in the direction along the X-axis is exemplified, but the present disclosure is not limited to such an aspect. The ink jet printer 100 may be a line type liquid ejecting apparatus in which the plurality of nozzles Nz are distributed over the entire width of the medium PP.

### 3-9. Other Modification Examples

The above-described ink jet printer 100 can be employed in various types of devices such as a facsimile machine and a copier, in addition to a device dedicated to printing. However, the application of use of the recording apparatus of the present disclosure is not limited to printing. For example, a recording apparatus that ejects a solution of a coloring material is used as a manufacturing device forming a color filter of a liquid crystal display device. In addition, a recording apparatus that ejects a solution of a conductive material is used as a manufacturing device for forming wiring and electrodes of a wiring substrate.

What is claimed is:

1. A control method of a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, the control method comprising:
an acquisition step of acquiring residual vibration information on residual vibrations in the pressure chambers after applying a voltage to one or more of the plurality of piezoelectric elements; and
a determination step of determining whether or not a first abnormality, which is an abnormality caused by the medium colliding with the liquid ejecting head, is generated based on the residual vibration information.

2. The control method according to claim 1, wherein
the residual vibration information includes first individual information on the residual vibration in the pressure chamber communicating with a target nozzle among the plurality of nozzles and second individual information on the J residual vibrations in the respective J pressure chambers respectively communicating with the J nozzles, in which J is equal to or greater than 1, continuous to the target nozzle, and
the determination step determines that the first abnormality is generated when an abnormality is detected in all of the residual vibration related to the first individual information and the J residual vibrations related to the second individual information.

3. The control method according to claim 2, wherein
the determination step determines that the first abnormality is not generated when an abnormality is detected in the residual vibration related to the first individual information and an abnormality is not detected in any of the J residual vibrations related to the second individual information.

4. The control method according to claim 2, wherein the J nozzles are nine or more nozzles.

5. The control method according to claim 2, wherein
the determination step further determines whether or not a second abnormality, which is an abnormality different from the first abnormality and is an abnormality of the liquid ejecting head caused by the liquid ejecting head, is generated based on the first individual information.

6. The control method according to claim 5, wherein
the determination step determines that the second abnormality is generated when an abnormality is detected from the residual vibration related to the first individual information and an abnormality is not detected in any of the J residual vibrations related to the second individual information.

7. The control method according to claim 2, wherein
the determination step determines whether or not the first abnormality is generated, by using an amplitude of the residual vibrations related to the first individual information and the second individual information and without using a period of the residual vibrations related to the first individual information and the second individual information.

8. The control method according to claim 7, wherein
the determination step determines whether or not a second abnormality, which is an abnormality of the liquid ejecting head caused by the liquid ejecting head, is generated, by using the amplitude and the period of the residual vibrations related to the first individual information and the second individual information.

9. The control method according to claim 1, further comprising:
by further using a server provided outside the liquid ejecting apparatus,
a transmission step of transmitting the residual vibration information acquired in the acquisition step from the liquid ejecting apparatus to the server; and
a reception step of receiving determination information indicating a determination result by the determination step from the server, wherein the server performs the determination step.

10. The control method according to claim 9, wherein
the liquid ejecting apparatus is provided with a storage section, and
in the determination step, when the liquid ejecting apparatus and the server are not connectable, the residual vibration information acquired in the acquisition step is stored in the storage section.

11. The control method according to claim 1, wherein
the liquid ejecting apparatus performs the determination step.

12. A liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium, the liquid ejecting apparatus comprising:
an acquisition section configured to acquire residual vibration information on residual vibrations in the pressure chambers after applying a voltage to one or more of the plurality of piezoelectric elements; and
a determination section configured to determine whether or not a first abnormality, which is an abnormality caused by the medium colliding with the liquid ejecting head, is generated based on the residual vibration information.

13. An ink jet system comprising:
a liquid ejecting apparatus that includes a liquid ejecting head having a plurality of piezoelectric elements, a plurality of pressure chambers which apply pressure to an internal liquid by respectively driving the plurality of piezoelectric elements, and a plurality of nozzles which respectively communicate with the plurality of pressure chambers and from which the liquid is ejected, and that is configured to eject the liquid onto a medium; and
a server provided outside the liquid ejecting apparatus, wherein
the liquid ejecting apparatus
acquires residual vibration information on residual vibrations in the pressure chambers after applying a voltage to one or more of the plurality of piezoelectric elements, and
transmits the residual vibration information from the liquid ejecting apparatus to the server, and
the server determines whether or not a first abnormality, which is an abnormality caused by the medium colliding with the liquid ejecting head, is generated based on the residual vibration information.
